(19) United States
(12) Patent Application Publication
(10) Pub. No.: US 2017/0161253 A1
(43) Pub. Date: Jun. 8, 2017

(54) System and Method for Dynamically Integrating Web Data, Services, and Functionality Into A Web Site

(71) Applicant: Upsyte Corporation, Madison, NJ (US)

(72) Inventor: Robert Silver, Madison, NJ (US)

(73) Assignee: Upsyte Corporation, Madison, NJ (US)

(21) Appl. No.: 15/354,896

(22) Filed: Nov. 17, 2016

Related U.S. Application Data
(60) Provisional application No. 62/256,156, filed on Nov. 17, 2015.

(51) Int. Cl. G06F 17/24; G06F 17/27; H04L 29/08

(52) U.S. Cl. CPC G06F 17/248; H04L 67/02; G06F 17/272

(57) ABSTRACT

A system for enhanced security and increased processing for dynamically integrating web data services and functionality into a web page is provided. The system can include a device (computer, PC, workstation, phone, tablet, etc.) connected to a network for allowing a user to access a web page described at least in part by a templating language. The system can further include a content platform having content to be integrated into the web page. The system can allow the device to execute a platform script once the user accesses the web page on the device, In some embodiments, the execution of the platform script causes the device to parse and interpret the templating language of the web page and to communicate with the content platform to retrieve content and incorporate the content into the web page. Finally, the system may display a transformed output to the user on the device.

### CROSS-REFERENCE TO RELATED APPLICATION

This application claims priority to United States Provisional Patent Application No. 62/256,156 filed on Nov. 17, 2015, which is incorporated herein in its entirety by reference and made a part hereof.

### BACKGROUND

Field of the Disclosure

The present disclosure relates generally to templating languages, and more particularly to customizing websites using templates.

Related Art

Due to advances and simplification of Internet-based activities, it has become much easier for the average person to create his or her own web content through, for example, a website. Such content creators may seek to implement advanced functionalities into their websites that improve the user experience and/or generate revenue. Without sufficient expertise in these advanced functionalities, however, a content creator must rely on a third party provider to implement the functionalities.

One specific example of content creators who rely on third parties to provide functionality includes merchants seeking to sell digital and physical products as well as services and licenses through websites. A wide variety of solutions are employed by such merchants to create e-commerce websites, including but not limited to: installing shopping cart software on servers under the merchant's control; outsourcing all, or a portion of their site to a “hosted platform” which provides a hosting environment maintained by a third party provider that incorporates built-in e-commerce functionality which a merchant can utilize and which may also provide tools related to e-commerce management; and integrated solutions, which involve adding e-commerce solutions that interface with a third party provider into a merchant's existing site.

Existing solutions range from simple to complex. As an example, a merchant may elect to purchase and install shopping cart software that resides on a server under the merchant's control. The disadvantages of utilizing installable software are numerous. The process of installing, maintaining and patching such software is not inconsequential. Major upgrades of the software typically require an additional investment of capital. Additionally, such carts can increase the cost of compliance with Payment Card Industry (PCI) requirements whose regulations apply, among other criteria, to merchants who process, transmit or store card holder data.

Instead of purchasing and installing shopping cart software, a merchant may elect to work with a hosted platform provider. Such providers typically offer at least two things, as the name implies: hosting services and a “platform.”

With respect to the “platform” part, this usually references the services and tools such a provider makes available for use with the built-in e-commerce capabilities. For instance, such providers typically make a “management portal” available to merchants which allows them to undertake actions such as defining products, subscriptions or licenses, uploading images, setting prices and adjusting settings such as the brands of payment cards or currencies accepted.

Such management portals also typically offer tools to manage orders, licenses, services or subscriptions, issue refunds, update the status of orders within a merchant's order processing process, automate shipment via various carriers such as FedEx® or UPS®, etc. The features offered within such portals are varied and may cover end-to-end business operations of merchants who choose to utilize the portals to their full potential. Additionally, the platforms may often offer “plug-ins” authored either by the hosted platform provider or by third parties which extend the capabilities of the portal and/or e-commerce services offered. The platform may also include other services or features, such as the ability to programmatically access or provide data to the platform such as via an Application Programming Interface (API).

The data that is created via the merchant's interaction with the platform is then utilized within the built-in e-commerce functionality provided to the merchant through their use of the hosting portion of the platform. For instance, some hosted platform providers may offer category detail pages that retrieve the data related to products such as name, price and images of the products, defined by the merchant in the platform, and place that information into the category detail page automatically or based on rules supplied by the merchant, for instance via specially crafted HTML markup.

The hosting services may range from being executed via a simple architecture, such as placing each merchant site into a separate shared hosting account, to complex architecture involving hosting a multitude of merchants on a shared, auto-scaling, load balanced cloud infrastructure. To this hosted environment, the provider adds built-in e-commerce capabilities which the merchant can utilize.

For instance, one provider may allow merchants to upload website pages to individual hosting accounts which may include custom server-side code so that the merchant can build a fully functional website while simultaneously also utilizing certain web pages which are shared between many merchants and implement e-commerce functionality (e.g., a checkout page). These shared pages are intentionally isolated from the rest of the content provided by merchants so that critical pages can be served in a highly controlled, secure and restrictive environment (such as by disabling a merchant's ability to provide server-side code to be executed on such pages) so that the burden of complying with regulations surrounding the acceptance of payments on the internet can be shared by the many merchants utilizing the system. Since merchants cannot change the underlying code of such pages, a single audit of these pages by the platform provider can be utilized by all merchants of the platform with respect to PCI compliance. The downside to such a system is that it usually results in merchants being highly restricted in terms of the customization of these shared pages, and usually results in a system in which merchants may be able to alter the CSS (Cascading Style Sheets) of such pages, but not much else.

In another example of architecture which might be selected by a provider to provide such hosting services, the provider might deploy many merchants across a shared, autoscaling, load balanced cloud infrastructure where all of the various merchants' pages execute across numerous servers within the same security context (e.g., within the same virtual machines). In such a scenario, a platform provider can save substantial amounts of money by sharing the underlying infrastructure between the merchants. The downside to such an architectural decision, however, is that any server-side customizations that a merchant would want to undertake could impact the security of the entire platform as it relates to every other merchant. For example, if a platform provider in such a scenario allowed a merchant to provide his or her own server-side code for execution on the shared infrastructure, the merchant could potentially infect the machines running the code and siphon off data resulting from activity occurring via the other merchants.

As a result, a platform provider electing to utilize such an architecture might attempt to provide an alternate method of customization for merchants operating within the infrastructure. As an example, there is one provider who makes available to merchants a templating language that merchants can embed within the markup of their web pages which executes server-side, on the provider's infrastructure, to integrate data made available by the platform into the pages provided by the merchant. The merchant could, for instance, utilize the templating language to loop through the various products that were defined in the management portal, discover their associated names, prices and images, and insert them into the page. By providing a templating language which the merchant utilizes to customize pages, the provider effectively provides a method of creating pages on the shared infrastructure that is limited by the nature of the templating language provided, which means that the provider can carefully control the security of the platform by controlling the underlying system resources that the templating language can access. The obvious disadvantage to such a solution is that merchants are limited in their ability to customize pages by the choices the platform provider makes with respect to the capabilities exposed by the templating language that the provider makes available.

As should be apparent, many varied designs may be contemplated for the implementation of a hosted platform solution. Such solutions do not require that a merchant utilize only the hosted platform for his or her entire website; for instance, a merchant might choose to maintain his or her own separate website and then utilize such a hosted platform within a sub-domain of the main site.

Rather than utilizing a hosted platform, a merchant might elect instead to utilize a solution which “integrates” e-commerce functionality into the merchant's existing website. As with hosted platform solutions, solutions in this space range from simple to complex. At the simplest end of the spectrum, merchants might list products or services for sale on external e-commerce websites and simply direct their visitors to external product listings via, e.g., providing a uniform resource locator (URL) linking to the listing. In a slightly more complex solution, a merchant might integrate a “buy now” button redirecting a potential customer to a third party provider to conclude a purchase.

Other more complex solutions may involve the integration of more complex data or functionality into the merchant's existing site, eliminating the need to direct potential customers away from the merchant's site and to a third party for the processing of payments. This is, of course, advantageous from the perspective of maintaining a uniform shopping experience, providing a more professional appeal to the site, and maximizing visitor retention and purchasing.

For instance, one existing solution provided involves a management portal, such as those offered in the hosted platform space, combined with JavaScript snippets that the provider makes available which the merchant places into the markup of his or her page. The JavaScript snippets, in turn, utilize client-side technologies to integrate e-commerce data made available by the platform (resulting, for instance, from a merchant utilizing a portal provided by the platform to configure information related to products) into the merchant's site. A disadvantage of this solution is that the resulting display of data which is inserted is not easily customizable. Layouts provided for the display of data are usually restrictive in nature and customizing pages which integrate this provider's solution to a high degree may require extensive utilization of an associated JavaScript API provided by the solution provider.

Yet another existing solution for integrating e-commerce functionality into merchant sites includes adding custom data attributes to HTML tags and adding a reference to a JavaScript script within the markup of a web page wherein the script then executes client-side in a web browser, collects data about the products being sold using the custom data attributes, provides a method of checking out (for instance, via a modal popup that collects payment information) and then sends the data to a third-party platform which helps handle administrative details such as order tracking (e.g., via a management portal). Use of such a method allows the merchant to implement e-commerce functionality while maintaining full control over the appearance of the merchant site. However, because such a solution fails to provide a method for obtaining data related to the products being sold, and relies on the merchant to provide the data that is placed into the custom data attributes which describe the products (e.g., from a database maintained by the merchant) such a solution is far more costly and time consuming than inserting preconfigured snippets of code.

Yet another existing solution for integrating e-commerce functionality into merchant sites allows a merchant to provide instructions for customizing scripts to be incorporated into the merchant's site respective of items displayed on the site. The instructions may be provided by the merchant via one or more fillable form fields. Once the widget is customized per the instructions, the widget may be added to the script of the merchant site. However, such a solution requires identification of items, which utilizes additional computing resources during execution and could yield failure to follow instructions if one or more items are not properly identified.

It would therefore be advantageous to provide a solution that would overcome the deficiencies of the prior art. More specifically, the present disclosure will demonstrate a better method for providing both integrated solutions and hosted platforms.

### SUMMARY

A system for enhanced security and increased processing for dynamically integrating web data services and functionality into a web page is provided. The system can include a device (computer, PC, workstation, phone, tablet, etc.) connected to a network for allowing a user to access a web page described at least in part by a templating language. The system can further include a content platform having content to be integrated into the web page. The system can allow the device to execute a platform script once the user accesses the web page on the device, In some embodiments, the execution of the platform script causes the device to parse and interpret the templating language of the web page and to communicate with the content platform to retrieve content and incorporate the content into the web page. Finally, the system may display a transformed output to the user on the device.

A method for enhanced security and increased processing for dynamically integrating web data services and functionality into a website is also provided. The method can include the step of providing a device (computer, PC, workstation, phone, tablet, etc.) connected to a network for allowing a user to access a web page described at least in part by a templating language. The method can further include the step of providing a content platform having content to be integrated into the web page. The method can also include the step of causing a platform script to be executed on the device once the user accesses the web page on the device. In some embodiments, the method can include the step of parsing and interpreting the templating language of the web page once the platform script is executed on the device. In some embodiments, the method can further include the step of communicating with a content platform to retrieve content and incorporate the content into the web page. Finally, the method may include the step of displaying a transformed output to the user on the device.

### BRIEF DESCRIPTION OF THE DRAWINGS

The foregoing features of the disclosure will be apparent from the following Detailed Description, taken in connection with the accompanying drawings, in which:

FIG. 1 is exemplary code of a template programmed according to the disclosed embodiments;

FIG. 2 is an web page output rendering based on the template code shown in FIG. 1;

FIG. 3 is a network diagram utilized to describe the various disclosed embodiments;

FIG. 4 is a flowchart illustrating a method for integrating e-commerce functionality into a web page according to an embodiment;

FIG. 5 is a flowchart illustrating steps for executing a platform script on a client device to transform a webpage based on communications with a content platform;

FIG. 6 is a flowchart illustrating steps for executing a platform script to transform a web page by automatically detecting, utilizing, and/or extending one or more templating languages incorporated into a web page;

FIG. 7 is a flowchart illustrating steps for executing a platform script to transform a webpage based on automatic data binding languages and real-time communication with a content platform;

FIG. 8 is a flowchart illustrating steps for parsing and/or interpreting one or more templates or templating language instructions on a middleware device (e.g., a server) and then incorporating the resulting output into a web page via a platform script;

FIG. 9 is a flowchart illustrating steps for executing parsing and/or interpreting one or more templates or templating language instructions on a server and then incorporating the resulting output into a web page via a platform script;

FIG. 10 is a flowchart illustrating steps for integrating content from a content platform into a web page using iFrames;

FIG. 11 is a flowchart illustrating steps for integrating content on a content platform into a web page using iFrames and a platform script;

FIG. 12 is a diagram illustrating an embodiment where the content platform provider also provides web hosting for merchants to utilize the disclosed invention;

FIG. 13 is a diagram illustrating an embodiment where the content platform is hosted on a separate environment than the merchant infrastructure; and

FIGS. 14A-AD are screenshots of an embodiment of the system of the present disclosure.

### DETAILED DESCRIPTION

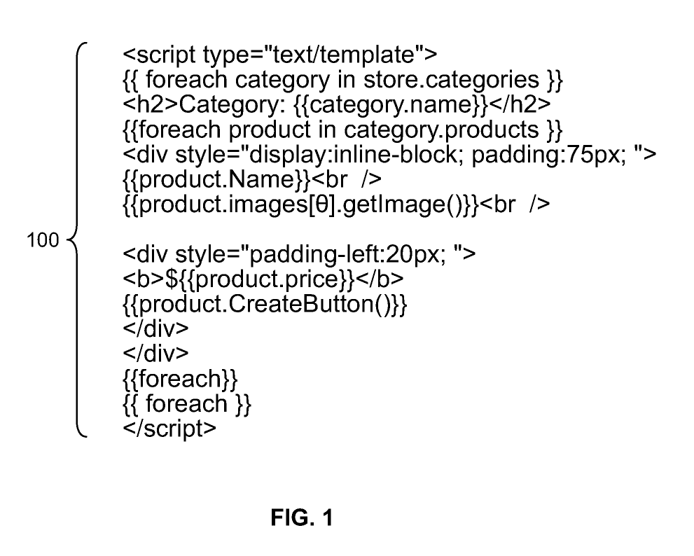

Disclosed herein is a system and method for dynamically integrating web data services and functionality into a web page, as discussed in detail below in connection with FIGS. 1-14AD.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Techniques for dynamically integrating web data, services and functionality into a web site are provided. The disclosed embodiments demonstrate a method for providing a content platform solution that enables content creators to customize web pages with data, functionality and/or services acquired from or implemented in concert with a content platform. More specifically, the method involves customizing web pages with instructions provided via a templating language, where the instructions, templating language functionality, content platform data, functionality and services, customizations to the page which result from the execution of the provided instructions, and/or data which results from the execution of the customized functionality are exchanged between the content platform and a client device viewing such customized pages via client-side mechanism(s).

The disclosed, non-limiting embodiments which follow will demonstrate that such a solution provides significant advantages compared to existing prior art related to both the “hosted platform” and “integrated” solutions discussed above as well as proving useful in a variety of other scenarios in which it would be advantageous for a content creator to integrate data or functionality made available through a content platform.

The content platform includes but is not limited to services, applications, software, websites, web applications, apps, mobile apps, Application Programming Interfaces (APIs), databases, data stores, and/or other electronic interfaces provided by the content platform provider which facilitate the consolidation of information retrieved, received, acquired or collected from, or on behalf of, one or more content creators. Such information may include, but is not limited to, templates, images, text, video, audio, and so on. The content collected may be specific to a particular purpose (for example, asking a content creator to define the various products to be sold on a website by providing a product ID, price and one or more images) and/or indirectly or tangentially related (such as asking for information related to various settings that influence the customization of the web pages).

Additionally, the content platform includes, but is not limited to, providing mechanisms that enable web pages to utilize the disclosed method to implement services or functionality which require the cooperation of the content platform or components thereof (e.g., displaying a list of items in a shopping cart within a customized page where the list of items in the shopping cart is maintained by and retrieved from the platform). One non-limiting example of such a mechanism is a Platform Script (also referred to as a content rendering script), detailed below.

The data retrieved, received, acquired or collected by or from the content platform and the services and/or functionality provided (individually or collectively, in addition to data, services and/or functionality acquired from elsewhere on the internet, “content”), may relate to or include any functions performed via the Internet such as, but not limited to, e-commerce functions (e.g, using product and inventory data stored in a platform), blogging functions (e.g, using blogging rules and data stored in a platform), website creation functions (e.g., using website content or other information stored in a platform), and so on. In an embodiment, the content platform may be hosted in a cloud computing platform or via cloud computing infrastructure. In another embodiment, the content platform may be implemented or hosted in a content delivery network or utilize a caching service, such as AWS CloudFront.

In a preferred embodiment of the present disclosure, a content creator (for instance, a merchant) wishing to integrate the data, services and functionality of the content platform integrates a Platform Script provided by the content platform provider into the web pages that the content creator wishes to customize. The Platform Script may be programmed in any client-side language implemented by a web browser, such as JavaScript. The Platform Script may be integrated into such pages by means including, but not limited to, explicitly retrieving the Platform Script from a remote location, directly embedding the script into the markup of the pages being customized, or adding a script reference to the markup of the page which causes a web browser to retrieve the script from a remote location, such as a server of the content platform, a Content Delivery Network, or from the server of the content creator, should the content creator choose to download and host the script him or herself.

In such an embodiment, the Platform Script provides functionality for obtaining content from the content platform, parsing and interpreting input based on a built-in templating language, providing the content to the templating language interpreter, locating within the web page templates constructed according to the rules of the templating language, interpreting such templates in conjunction with the content obtained from the content platform to produce output, and replacing the templates in the page with the resulting output. In some embodiments, the output may contain mechanisms which allow content to be acquired from and/or provided to the content platform (“communicative mechanisms”). Additionally, the process of interpreting the templates may result in the injection into the page of functionality and/or communicative mechanisms. Additionally, the process of interpreting the templates may result in content being provided to the content platform. When refreshing a template that has already been replaced, in certain embodiments such a process may involve replacing existing output with resulting output. In some embodiments, the page may be constructed based on the transformed templates and/or transformation process.

In a preferred embodiment, the partial parsing and interpreting of an exemplary templating language occurs by way of Parser Expression Grammar rules parsed by a freely-available client-side script known as PEG.js, which the Platform Script causes to be loaded, and interpreted in part by the rules passed to such parser and in part by the Platform Script. Many possible implementations of a templating language could be contemplated. Interpreting a templating language may include transforming placeholder parameters included in the template into replacement values. The replacement values may be included in the content acquired from or provided by the content platform.

The output produced by the Platform Script and/or independent functionality implemented into the Platform Script and/or functionality and/or communicative mechanisms injected into the page may cause the browser from time to time, or based upon certain conditions, or in response to certain events, to reconnect to the content platform to provide content to the platform or retrieve refreshed, new or additional content from the platform. This refreshed, new or additional content may result in causing the templates in the page to be re-interpreted, or the data may be utilized in other ways which do not require templates to be re-interpreted. For example, a template may result in output that is injected into a page which contains a <div> element to hold text retrieved from the platform, and additional text, when retrieved, may simply be injected into such a <div> element rather than updating the <div> by re-interpreting the template that created it.

The Platform Script, executed by the browser, could from time to time require a reconnection to the content platform to check for new text to add to the div. Upon the acquisition of new data, the template that produces the <div> element could either be re-interpreted and its new output injected into the page, or additional text elements could simply be appended to the <div> if the Platform Script were to keep track of individual elements and the content linked to such elements. If the implementation of a particular content platform requires the refreshing of data via the Platform Script, then the Platform Script may implement a mechanism for storing templates once they have been removed from the web page as a result of the first content replacement, so that they may be re-interpreted and the current output in the web page replaced with the refreshed output.

In some embodiments, to customize a page, templates are added to the markup of the page to be customized. In some embodiments, the templates must conform to certain rules prescribed by the implementation of the templating language in the Platform Script. In the preferred embodiment and certain other embodiments, the templates may be formed from a combination of templating language markup or code and any additional markup, code or content that a content creator would want to output into a page. For instance, in the preferred embodiment, templates may contain both templating language code and additional HTML, JavaScript and CSS which is to be utilized in constructing the output to be injected into the page. This allows a content creator to mix templating language constructs alongside HTML, JavaScript and CSS so that replacement values obtained from the content platform are not only inserted in certain locations within a page but also so that the markup or code not obtained from the content platform can be controlled and the content obtained from the platform seamlessly integrated with it. It should also be noted that, in certain embodiments, the templating language implemented by the Platform Script can utilize data not only obtained from the content platform, but also data from elsewhere (such as additional data defined within the Platform Script itself or data elsewhere on the internet).

Exemplary and non-limiting features of a template language that may be utilized with the preferred embodiment are disclosed below.

FIG. 1 shows an exemplary and non-limiting block of code 100 implementing a template to be inserted into a web page in an exemplary and non-limiting example of one particular embodiment of a templating language that could be implemented. This exemplary code may be utilized in a web page to inject e-commerce functionality supported by a content platform. This example code iterates over a “store” object retrieved from the content platform in JSON format and displays every product in the category, thereby allowing a content creator to create a category display within a web page by adding such a template to the markup of a web page. Although in the preferred embodiment the JSON object is retrieved from the content platform and then iterated as a result of the interpretation of the templating language, it should be noted that on-demand retrieval of data from the content platform to be utilized in conjunction with the templating language could occur, such that a statement could be parsed or interpreted, data which needs to be obtained from the content platform recognized, and the data subsequently retrieved prior to parsing or interpreting the next statement. It should also be appreciated that other timing with respect to content retrieval and templating language parsing or interpretation may be contemplated. As can be clearly seen, the template of FIG. 1 demonstrates mixing both templating language markup or code (with respect to templating languages, “markup” and “code” may be used interchangeably to describe templating language instructions and/or a template or its contents), including flow control structures such as for each loops, with standard HTML and CSS.

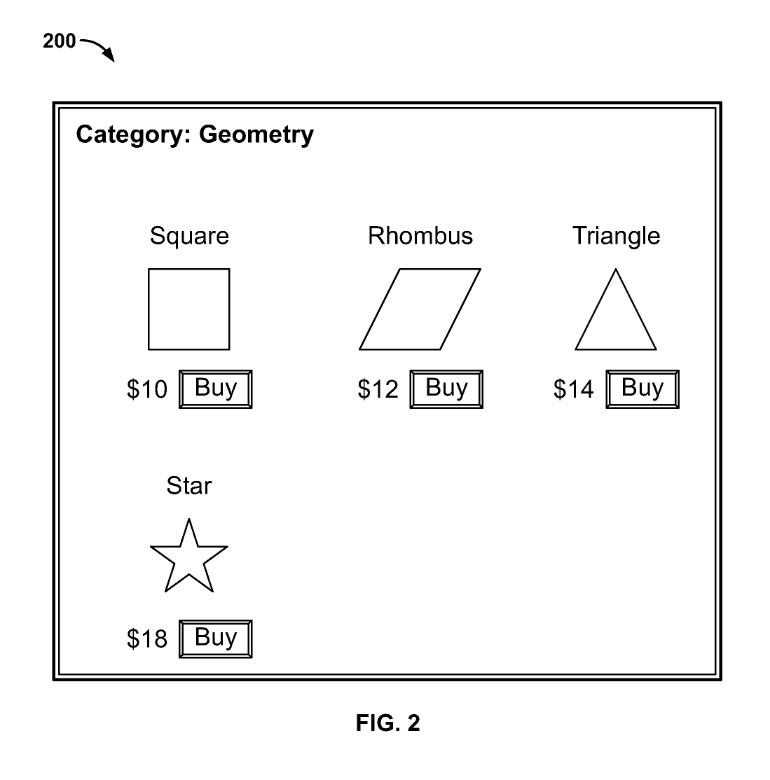

FIG. 2 is an exemplary and non-limiting web page (or a portion thereof) 200 rendering of output after executing the block of code 100. As can be seen, the ability to mix templating language markup with HTML, JavaScript and CSS provides flexibility with respect to a content creator integrating content from the content platform into other markup, code or content of the content creator's choosing. It should be noted that any markup, code or content contained within the template that is not part of the templating language may be any type of markup, code or content of the content creator's choosing.

In analyzing FIG. 1, the first notable feature of the template is that it is implemented using a script block which has its type attribute set and where that attribute is set to a value other than, for example, text/javascript. This value prevents the web browser from interpreting the script block as JavaScript. By the placing templating markup and additional markup, code and/or content within the script tags, the templating markup and additional markup, code and/or content are ignored by web browsers, such that the Platform Script, when executed by the browser, will be able to obtain the script elements and extract the unmodified text of those script elements for parsing and interpretation. It should be noted that other embodiments of a templating language may depart from this convention. For instance, certain embodiments of the templating language may be implemented such that templates can be placed completely inline with page markup and recognized simply by the tokens utilized to indicate a template command e.g. {{and}}, or by simply recognizing identifiers to be replaced with values simply by the position of the identifier within certain locations within page markup, or according to information placed within data attributes. Additionally, certain other embodiments which may be implemented could contemplate using advanced (and not yet fully supported) HTML5 features implemented in certain browsers, such as <template> tags to integrate templates into page markup.

Next, it should be obvious from a simple examination of FIG. 1 that the non-limiting and exemplary templating language of the preferred embodiment supports various types, objects, identifiers, variables, statements, operators, data structures, flow control structures and methods such as those found in other programming languages. For example, the types implemented by the disclosed templating language may include strings, numbers, booleans, and objects. Data structures may include arrays and objects. For simplicity, user-defined variables have been omitted from the built-in templating language of the preferred embodiment, though variables defined by content retrieved from the content platform are supported (as shown, for example, by {{product.name}}, where the product is a JSON object obtained from the content platform, and the name is a member variable implemented by the JSON object). Note that returning JSON is not a requirement and there is no restriction on the data formats which can be returned by the content platform; it is simply a useful and easily utilized data format. Certain embodiments of the exemplary templating language implement flow control structures capable of operating on arrays, maintaining state with respect to the current variable being iterated, and/or duplicating markup contained between the opening and closing statements of the structure while also recursively interpreting any additional templating language markup contained within such markup, such as for each loops.

The next notable feature within FIG. 1 is the presence of methods attached to certain objects. Methods and properties, combined with the ability to pass data from sources other than the content platform to the exemplary templating language implemented by the preferred embodiment, are the primary mechanisms for not only implementing extensions to the language but also in large part for implementing the “services and functionality” disclosed.

For instance, FIG. 1 contains a statement, {{product.CreateButton( )}} which indicates a function (also referred to as a “method”) “CreateButton” should be called and is implemented on an object “product” which was passed to the interpreter. In the preferred embodiment, the implemented templating language interpreter will iterate over the members of an object passed to it and search for a function that matches the parsed name, in this case “CreateButton”. If found, it will be executed by the templating language interpreter. Additionally, although not shown, such functions may also accept arguments whose values are derived from the templating language markup or code within the template. As a result of the ability of the exemplary templating language to call functions or methods attached to objects, objects which are obtained from the content platform can be provided with additional functionality via additional code incorporated into the Platform Script (for instance, once the object is retrieved, the new function is attached) which is then called as a result of the interpretation of a template. It should be appreciated, however, that the additional functionality need not be implemented within the Platform Script but could also be retrieved or received from other locations, such as the content platform, a web service, or a third party location such as a centralized “snippet” platform or service. Additionally, it should also be noted that callable functions or methods may provided by other means, such as through the ability to call a function without specifying an object, or the ability to call a function on certain types (e.g., functions which can be called from variables of type “string”).

The interpreter implemented by the Platform Script of the preferred embodiment can utilize such object extensions to call functions which are implemented in JavaScript. As a result of the ability of the Platform Script of the preferred embodiment to call JavaScript functions when encountering functions within a template, advanced functionality can be incorporated into such customization mechanisms. For instance, when the “CreateButton” function is called, it could not only return HTML markup that renders a “Buy” button but also add additional JavaScript within the page which causes the button, when clicked, to cause the Platform Script to have the browser contact the content platform to add an additional item to a shopping cart. It should be appreciated that the possibilities for customization of the templating language are nearly endless, and that certain embodiments may support customization of the templating language provided not only by the content platform provider but by the content creator as well.

In certain embodiments, the content creator may be provided the opportunity to extend the templating language by adding his or her own customizations. Customizations may include but are not limited to, methods and properties and new statements or control structures (e.g., loops). In other embodiments, the content creator may elect to host the Platform Script on the content creator's server and modify the Platform Script to include such customizations. In yet other embodiments, the content platform may provide a method for specifying language customizations which are then injected into or utilized by the Platform Script. In another embodiment, language customizations may be incorporated via an external file (e.g., an additional JavaScript file or a text file) which is incorporated into the Platform Script (for example, by code that retrieves the external file). In certain embodiments, the external file may be hosted by the content creator and in other embodiments, within the content platform or in another remote location. In still other embodiments where language customizations are directly incorporated into the Platform Script, the content creator may be permitted to select which customizations to include, so that by including fewer language customizations, the file size of the Platform Script may be reduced. In other embodiments, the customizations may be directly injected into the Platform Script. It should be noted that a platform provider may use such varied techniques to customize the templating language as well.

By providing opportunities for the customization of the language by content creators, a platform provider can offer a highly customizable solution. Even in scenarios such as providing hosting for content creators across a shared server farm where content creator pages are not isolated, content creators could be provided means to extend the exemplary language of the preferred embodiment in a way that does not interfere with other content creators since the exemplary templating language of the preferred embodiment executes in a client-side context.

Additionally, the exemplary templating language of the preferred embodiment supports passing data not obtained from the content platform into the templating language interpreter. Such functionality provides for further incorporation of customizations into the templating language such as by introducing custom objects into the available language (for instance, such a feature might be utilized to implement a “counter” object that can be passed to the interpreter and utilized to keep track of for each loop iterations). In another non-limiting example, such a feature might be utilized to introduce various “helper” objects into the language, such as a helper object that can be utilized to construct consistently formatted URL links within a page. In certain embodiments of the exemplary templating language, it may be beneficial to provide objects to the templating language interpreter in such a manner so as to avoid latency-introducing communications by the browser to the content platform to obtain objects that introduce functionality which do not require that the data or functionality utilized be obtained from the content platform (for instance, because the functionality does not reside within or depend upon any content contained in the content platform).

As may be apparent, customizations to the templating language may be used to great effect in implementing services and functionality which operate either independently from, dependently with, or cooperatively with the content platform. To provide several non-limiting examples: in certain embodiments, the Platform Script may contain language customizations to expose shopping cart functionality included in the Platform Script which operates entirely client-side and does not need to cooperate with the content platform; in certain embodiments, the Platform Script may implement a client-side shopping cart which depends upon data obtained from the content platform but does not store data on the content platform; and in certain embodiments, the Platform Script may implement a shopping cart which requires cooperation from the content platform, for example to store the items saved.

It should be appreciated that utilizing the language customization features disclosed, it would be possible to provide both low-level and high-level functionality through the exemplary templating language. Additionally, it should be appreciated that the language itself may be extended to provide functionality. For instance, while complex objects cannot typically be directly output by the exemplary templating language, it would be possible to extend the exemplary templating language with an additional feature such that a {{cart}} statement could simply be added into a template which might result in output being produced in accordance with the manner in which the {{cart}} statement is implemented, in addition to data provided to the cart statement, if data arguments are accepted, in addition to rules or preferences set in the content platform, in addition to content obtained from the content platform. Consequently the {{cart}} statement may produce an output button that, when clicked on by a user of a client device, causes a sliding animation and displays a miniature shopping cart including any selected items. The display, including any layouts and/or animations, may be further customized by the content creator through the content platform (e.g., via the management portal).

Although not shown in FIG. 1, the template of FIG. 1 is intended to be placed inline into HTML within HTML tags that directly support HTML content, such as <div>, <p>, <td>, etc. because all output generated by the exemplary templating language is automatically HTML encoded, unless a special procedure for unencoding such content is followed. As discussed above, the placement of templates in other embodiments of a templating language may require or allow for different placement within a web page.

The disclosed embodiments may be based in part on content rendering (CR) scripts and utilizing predesigned templates. The CR script may be programmed using any scripting language, e.g., JavaScript. The disclosed embodiments further allow for customizing a web page or creating a new web page by adding one or more templates to the web page in locations where it is desirable to display information obtained via a content platform. A web page programmed to integrate web data and/or services includes a CR script or a call for such a CR script. The CR script, when executed, processes the template code, thereby causing dynamic insertion or injection of the content to the web page. In some embodiments, such insertion or injection may result in rendered content.

As will be discussed below, the content is obtained from a central repository. Each template may include HTML and/or templating language code which may be utilized to retrieve data and produce HTML to be output by a web page. In a preferred embodiment, the CR script is executed as a client-side script, thereby decreasing the load on web host servers.

The disclosed embodiments provide a flexible yet simple technique for integrating web content and/or services into web pages and, in particular, into existing web pages. In some embodiments, a graphical user interface may be utilized to allow users to visually select templates to be added to a web page. The web content and/or services may include, but are not limited to, functionality related to e-commerce platforms, blogging platforms, website creation platforms, and so on.

FIG. 1 shows an exemplary and non-limiting block of code 100 implementing a template to be inserted into a web page. This exemplary code may be utilized in a web page to inject e-commerce functionality supported by a platform (e.g., the content platform). This exemplary code retrieves every category defined in the platform and displays every product in the category, thereby allowing a user (e.g., a system administrator) of a web site to create a category display within a web page by adding the code to the web page. FIG. 2 is an exemplary and non-limiting web page (or a portion thereof) 200 rendering of output after executing the block of code 100, as discussed above.

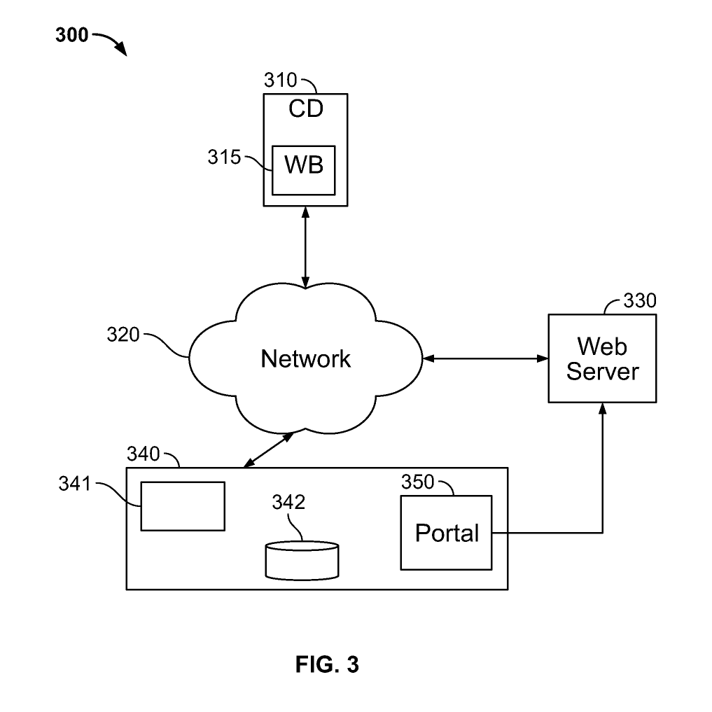

In order to understand the flow of operations of the preferred embodiment, FIG. 3 should be referenced. FIG. 3 shows an exemplary and non-limiting networked system 300 utilized to describe the various disclosed embodiments. It will be understood that some of the embodiments disclosed may require different systems or components in order to be properly executed. The networked system shown includes a client device (CD) 310, a web server 330, a content platform 340, and a web portal 350 communicatively connected to a network 320. The network 320 may be the Internet, the worldwide web (WWW), similar networks, or any other type of network. It should be noted that a single client device 310 and web server 330 are shown merely for simplicity purposes and without limitation on the disclosed embodiments. In a typical deployment, multiple client devices and/or multiple web servers may carry out the disclosed embodiments.

The client device 310 may be, but is not limited to, a smart phone, a mobile phone, a laptop, a tablet computer, a wearable computing device, a personal computer (PC), and the like. The client device 310 is configured to execute a web browser (WB) 315. The web browser 315 may be any software that is capable of accessing information over the network 320 and displaying web pages, e.g., a web browser (e.g., Chrome®, Firefox®, Internet Explorer®, etc.). In a certain embodiment, the web browser may be realized as a mobile application (app). Such a mobile application can be downloaded from repositories, such as AppStore®, Google Play®, and so on, and installed on the client device. In another certain embodiment, the web browser may be realized as a component within an application (e.g., via a browser component that is only part of an application).

The web server 330 is configured to host, execute, or otherwise maintain websites, web applications, mobile applications, and the like. When a user of the client device 310 attempts to view a web page over the network 320, the web browser 315 sends a request (e.g., an HTTP request) to the web server 330 to provide the web page. In response, the web server 330 responds (e.g., by sending an HTTP response) with the requested web page. In certain embodiments, the code and/or markup for the web page to be provided by the web server 330 may be maintained (e.g., in a database) by the content platform 340 and retrieved by or provided to the web server 330.

When the web browser 315 of the client device 310 receives the web page, it may find the Platform Script embedded or may require a call to an external location to obtain the Platform Script. Because this particular embodiment of the Platform Script relies on a popular JavaScript library, JQuery, to begin execution on a fully loaded Document Object Model (DOM) in a browser-agnostic manner, the Platform Script is actually implemented in two parts: a stub script, which first causes prerequisite scripts, such as JQuery and PEG.js to be loaded, and then causes the actual implementation of the Platform Script to be acquired separately. Despite being implemented in multiple physical scripts, the Platform Script is a single conceptual unit and so we refer to it as such. In certain embodiments, the Platform Script may be implemented as a single script or many scripts.

The Platform Script is obtained and then executed by the web browser 315 once the Document Object Model (DOM) is fully loaded, in accordance with the manner in which the Platform Script is programmed.

In an embodiment, the content platform 340 may be implemented or hosted in a content delivery network. In certain embodiments, components of the content platform may be delivered from separate cloud services which may or may not require traversing the internet. In yet other embodiments, the content platform may be comprised of services utilized in connection with a service such as AWS CloudFront which would allow for data, functionality, components of, or data resulting from interaction with, the content platform to be served dynamically, statically or from a cache.

In an embodiment, the content platform 340 may include one or more servers 341 and a data warehouse 342. The server 341 may be configured to retrieve data from the data warehouse 342. It will be understood that although the server 341 and data warehouse 342 are shown within the confines of the content platform 340, the data warehouse may be located elsewhere, and the server 341 may communicate with the data warehouse 342 through the network 320 rather than directly. Additionally, in some embodiments, a data warehouse may consist of multiple data stores, multiple data warehouses may be utilized, and/or such data stores and/or data warehouses may be utilized separately or in conjunction with one another through the network 320. It should also be understood that in certain embodiments, the data acquired by the content platform does not need to be stored in the data warehouse but may instead pass through the content platform (for instance, real-time shipping rates acquired from a web service). In other embodiments, the content platform server 341 may also be the data warehouse 342. In some embodiments, the content platform 340 further includes a portal 350 for managing the content platform 340, which will be discussed in more detail below.

According to some embodiments, the content rendering includes dynamic (and during run-time) processing of one or more templates embedded in a web page. In certain embodiments, a template may be programmed using a templating language such that it may be interpreted to render HyperText Markup Language (HTML) output. Interpreting the templating language may include transforming placeholder parameters included in the template into replacement values. The replacement values may be included in the data contained in the content platform 340. The templating language may be implemented using a scripting language. One possible implementation for a templating language is discussed above.

The processing of a template's code and rendering of the content respective thereof may be performed by a CR script, which may be an implementation of a platform script discussed elsewhere herein. The CR script, when executed by the client device 310, causes retrieval of replacement values, parsing of the templates in the web page, and content rendering based on the processed (interpreted or transformed) templates. The process for rendering web content by the CR script is disclosed in further detail herein below.

It should be noted that, in certain embodiments, the CR script may be executed by a server 341 of the content platform 340 or by the web server 330 without departing from the scope of the disclosed embodiments. In an embodiment, the CR script may be uniform among the client devices 310, the web server 330, and/or the platform 340. This uniformity enables different web pages (or different versions of the same page) to utilize different templates through the same platform 340.

The content platform 340 may be further communicatively connected to the portal 350. The portal 350 is configured to allow a user (e.g., a system administrator) of a web site hosted on the web server 330 to interact with the content platform 340 by performing actions such as, but not limited to, selecting templates, customizing templates, managing and uploading content to the content platform 340, modifying settings and preferences for the web page or for the content platform 340 and the CR script, and so on. For example, if the website is an e-commence website, then the content may include, but is not limited to, categories of products, collections of products, products, prices, images, discounts, sales, and so on. As another example, if the website is a blog, then the content may be a blog name, dates, blog content, and so on.

The Platform Script executed by the web browser 315 may be configured to retrieve content from the content platform 340 via the server(s) 341 connected to the data warehouse 342. The Platform Script may then utilize the retrieved content in connection with the exemplary templating language of the preferred embodiment as previously disclosed. For example, if the web-site is an e-commerce website, then the content may include, but is not limited to, categories of products, collections of products, products, prices, images, discounts, sales, and so on. As another example, if the website is a blog, then the content may be blog names, dates, blog content, and so on.

When the Platform Script retrieves content, the retrieved content may include the totality of the information possessed by the content platform or a constrained portion thereof. The constraints on the information retrieved by the Platform Script may be imposed through multiple means, including but not limited to through settings defined and indicated by the content creator through the content platform, through client-side code embedded in the page to be customized which is capable of interacting with the client-side code in which the Platform Script is implemented, through settings provided to the Platform Script via the templates implemented by the content creator, or via automated capabilities implemented within the Platform Script.

By way of example, the Platform Script may constrain the amount of data required by utilizing URL or query string parameter scanning to recognize certain pages (for instance, a “category” page) and then cause information only required for that specific category to be obtained, as well as certain other information that may pertinent to such a page.

In accordance with certain disclosed embodiments, the Platform Script, executed by the web browser 315, locates the templates within the page, parses and interprets them utilizing the built-in templating language parser and interpreter in conjunction with the obtained content, and then injects the output into the page, replacing the templates. According to some embodiments, the output may contain communicative mechanisms and/or functionality (as a non-limiting example, JavaScript that executes when a button contained within the output is clicked). According to other embodiments, the interpretation or transformation of a template may result in communicative mechanisms and/or functionality being injected into a web page (as a non-limiting example, JavaScript which is not contained within the transformed output is injected into the page). In certain embodiments, one or more communicative mechanisms may be implemented via the Platform Script. In certain embodiments, where one or more communicative mechanisms and/or functionality is provided for acquiring content from or providing content to a content platform, then the acquisition of content from a content platform prior to the interpretation of a template may be optional. In certain embodiments, where one or more communicative mechanisms and/or functionality results from the transformation of a template, the transformation of the template may not result in output or may result in output which is not rendered or which is optional. In certain embodiments, the acquisition of content from a content platform or providing of content to a content platform may occur at different times within the lifetime of a visit to a web page, such as after a page has already been loaded. According to some embodiments, the process includes dynamic (and during run-time) interpretation of one or more templates embedded in a web page. In other embodiments, transformation may occur at another point in time, such as during compilation. Where the “interpretation” of a template is referenced, it should be broadly interpreted as the “transformation” of a template. By allowing the Platform Script to retrieve content directly from the content server 340 without having to go through the web server 330, the system provides significant technical advantages, namely, enhanced security, faster processing speeds, increased customization, and greater scalability. The system of the present disclosure provides for enhanced security because the customization of a web page is completed client-side and such customizations therefore do not affect the security of the servers from which the web page is served. Furthermore, the system of the present disclose provides for faster processing speeds because the speed at which information is exchanged between the client device and the content platform is faster than introducing a third-party web server as an intermediary. Further, the system of the present disclosure allows for greater scalability because the content platform can be designed utilizing cloud computing architecture that is designed to be scalable. Since the Platform Script causes a web visitor's web browser to interact directly with the content platform, the merchant's server requires relatively fewer resources to serve a page since the resources necessary to the customization are provided by the scalable content platform instead. Additionally, merchants may benefit from the amortization of the cost of the necessary architecture resources across the content provider's customer base.

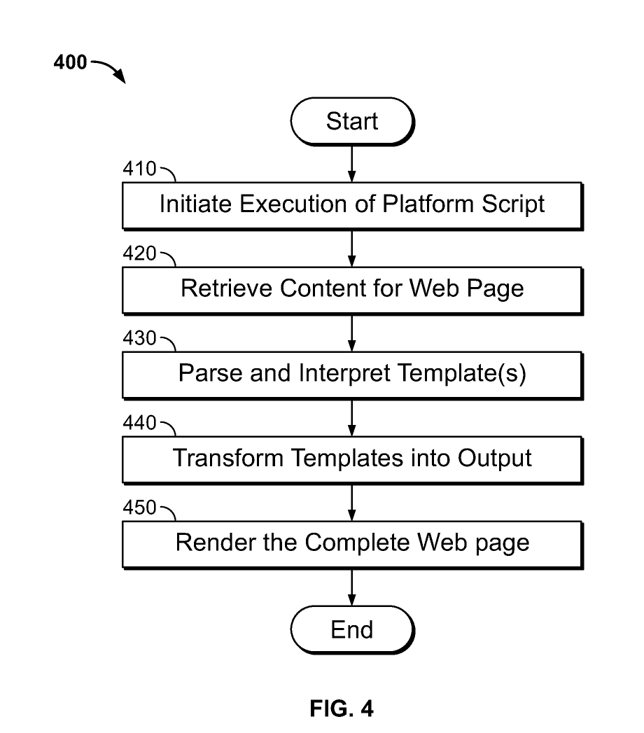

FIG. 4 is an exemplary and non-limiting flowchart 400 illustrating a method for dynamically implementing content into a web-site according to an embodiment. In an embodiment, the steps of flowchart 400 may be performed by any of a web browser (e.g., the web browser 315), a web server (e.g., the web server 330), and a content platform (e.g., the content platform 340). At S410, execution of the Platform Script is initiated. As noted above, the Platform Script is incorporated into a web page that also includes one or more templates in some embodiments.

In response to execution of the Platform Script, at S420, content appropriate for the particular web page is retrieved. The content includes data stored on a platform (e.g., the content platform 340).

At S430, each template in the web page is parsed and interpreted and at S440 the templates are transformed into output using the retrieved data or content. In some embodiments, prior to retrieving the web data, or content, each template in the web page is parsed in order to identify web data, or content, necessary to transform the templates. At S450, the templates embedded in the web page are replaced with HTML markup, JavaScript and CSS to render the complete web page. In certain embodiments, a syntax check is performed by the Platform Script to verify that a template has been used in a safe location within the web page.

According to certain non-limiting embodiments, the parsing is performed in two steps. First, parsing is performed to generate a set of expressions based on content placed between predefined tokens (e.g., {{and}}). Such parsing may be performed by a parser or an interpreter utilized to interpret input (such as, e.g., PEG.js, which is an interpreter written to be utilized with JavaScript). The interpreter is configured with a set of rules, based on the templating language, in order to interpret the templates.

According to certain non-limiting embodiments, the content to be parsed is sent to the interpreter by the CR script. In an embodiment, the CR script is also configured to process higher level functions. Examples for such functions may include, but are not limited to, iteration state, tag (brace) matching, and the like. In other embodiments, such functions may be handled elsewhere, for instance via the interpreter.

In an embodiment, to allow the interpreter access to variables of the template, such variables should be passed to the interpreter at runtime. The CR script gathers and encapsulates the variables and their values into a single object. The interpreter is configured to search for the object including the encapsulated variables.

The content platform 340 may further include a portal 350 which allows a content creator of a web site hosted on the web server 330 to interact with the content platform 340 by performing actions such as, but not limited to, selecting templates, customizing templates, managing and uploading content (as relates to the content platform), managing content not directly related to the content platform, managing data or content that results from the services or functionality incorporated into the customized web page as a result of the disclosed embodiments and which is provided to the content platform, modifying settings and preferences for the web page or for the content platform 340 and the Platform Script, incorporating third party services, and so on. In certain embodiments, the portal 350 may be hosted separately from the content platform. In embodiments in which the portal 350 is hosted separately from the content platform, the content platform may be communicatively connected to the portal. In some embodiments, a graphical user interface may be utilized to allow users to visually select templates to be added to a web page.

In an embodiment, the portal 350 may be a graphical user interface which coordinates with one or more web services, servers, data stores, and so on. In a further embodiment, the portal 350 may allow users to graphically add templates to a web page by, e.g., dragging and dropping a portion of content, editing output text, modifying the appearance of a portion of content, and so on. In another embodiment, such modifications may occur as a result of interacting with an iFramed page within the portal that retrieves a page to be customized from a remote location. In another embodiment, the graphical user interface within the portal may simply assist the graphical creation of templates which are then added to the page to be customized.

In another embodiment, the Platform Script executed in the web browser 315 may provide an administrative mode providing a graphical user interface which enables a content creator to interact with the web page provided by the server 330 via the web browser 315 on a client device 310 to add templates (graphically or otherwise) to the web page by, e.g. dragging and dropping a portion of content, editing output text, modifying the appearance of a portion of content, and so on, and then transmitting the selected preferences back to the content platform to be utilized in conjunction with future visitors to the web page. Another embodiment may include restricting access to administrative mode e.g., by filtering administrative commands sent to the content platform by IP address or a special cookie possessed by the content creator since such restrictions cannot currently be adequately implemented within client-side technologies.

In another embodiment, the web browser 315 may access a visitor portal (not shown). The visitor portal may be accessible to visitors of web pages hosted on the web server 330 that include the Platform Script. The visitor portal is configured to allow visitors to the web page to manage, e.g., purchases, past orders, invoices, subscriptions, blog posts, and so on. In certain embodiments, including the Platform Script may not be a required for utilizing the visitor portal. In an embodiment, the visitor portal may be provided via an iFrame embedded in the web server 330. In another embodiment, the web page on the web server 330 may redirect the web browser 315 to a visitor portal of the content platform 340. In another embodiment, the visitor portal may be incorporated into the web page to be customized via the Platform Script.

In another embodiment, the various components of the content platform may be customized utilizing a Platform Script. By way of a non-limiting example, the management portal provided to content creators may accept customizations to the portal via the disclosed techniques made possible in part by the Platform Script (in the same way that a content creator would utilize the Platform Script to customize web pages on the web server 330). In other embodiments, such customizations might be made utilizing the disclosed techniques not requiring a Platform Script.

In an alternative embodiment, access to the content of the content platform 340 may be provided via an application programming interface. In such an embodiment, the application programming interface may be utilized by the client device 310, by the web server 330 to retrieve content from or provide content to the content platform 340, or by separate servers or client devices (for instance, by the server of a third party to whom the content creator wishes to grant access to the content of the content platform).

In certain embodiments, content is cached to accelerate the serving of such content to the client device. In a further embodiment, the content platform 340 may include a cache server (not shown) or utilize a cache service (not shown) for caching web content.

In order to provide the content, instructions, templates, data, functionality, output, communicative mechanisms, placement data, etc. to the client device 310 for constructing or rendering the completed output and/or web page, a communication channel should be established between the client device 310 and the content platform 340. Existing communications technologies that can be used to facilitate communication between the client device 310 and the content platform 340 may include, but are not limited to, AJAX, Comet, WebSockets, and JSONP.

In an embodiment, AJAX may be utilized to allow asynchronous communications between the client device 310 and the content platform 340. In a further embodiment, Cross Origin Resource Sharing (CORS) may be utilized in combination with AJAX to allow cross-domain communications to and from the client device 310. In a further embodiment, an origin header may be sent by the client device 310 with a CORS request. The origin header may be utilized to validate the request by, e.g., comparing the sent origin header to origin headers associated with authorized web sites. In another embodiment, an origin header is sent by any client-side communications technology capable of sending an origin header. In certain embodiments, this origin header may be utilized not only to validate requests but to provide unique Platform Scripts, language customizations or other data on a per-origin basis. In an alternative embodiment, JSONP may be utilized to allow cross-domain communications to and from the client device 310.

In another embodiment, the templating language utilized by the method may not be the templating language of the preferred embodiment. Instead, the Platform Script may acquire, or the content platform may provide, a templating language made available by a third party. In certain embodiments, such a third party templating language may be acquired from remote locations not operated or maintained by the content platform provider. Additionally, in another embodiment, the content creator may include a templating language of his or her choosing in a page (e.g., by referencing a remote script that implements one), which the Platform Script may be capable of detecting and automatically utilizing in conjunction with the Platform Script's other capabilities. In yet another embodiment, a content creator may specify via the content platform a templating language to be utilized (selecting from one or more languages made available by the platform) which may then be retrieved by or sent to the browser via the Platform Script and automatically integrated with the Platform Script's other capabilities. As a non-limiting example, the Platform Script may acquire content from the content platform, provide access to the content to the third party templating language, and then signal to the third party templating language to begin interpretation of templates in the page according to the rules of the templating language being utilized.

In another embodiment, the templates interpreted by the Platform Script may be acquired from a location other than the markup of the web page served by web server 330. In a certain embodiment, templates may be stored in an external or separate file and incorporated during the page customization process. In certain embodiments, that external or separate file may be hosted by the content creator, in others by the content platform, and in others by a third party. In another certain embodiment, templates may be injected directly into the Platform Script according to the specific web server 330 which the Platform Script is referenced from (for instance, by utilizing an origin header to determine the domain name associated with the request and returning a unique Platform Script utilized only for that domain). In another certain embodiment, templates may be specified within the content platform and acquired as other content would be acquired. In another certain embodiment, the templates may be stored by the content creator via other means and injected into the markup of the page (e.g., in a database that the content creator maintains). In another certain embodiment, templates may be stored in a remote location other than the content platform which is directly accessible by code included in the Platform Script (e.g., direct, remote database access).

In such embodiments where templates are not directly added to the markup of a web page, the Platform Script may be adapted to obtain data related to the placement of the output generated by the interpretation of the templates and to utilize that placement data to determine where to inject or replace output in a page. Additionally, in certain embodiments, the Platform Script may also obtain instructions related to the injection of functionality (e.g., instructions to insert additional JavaScript) or communicative mechanisms into a page.

In another embodiment, Comet may be utilized to push data to the client device 310. In yet another embodiment, WebSockets may be utilized to enable dual-channel communications between the client device 310 and the content platform 340 in real-time or near real-time. In either case, the utilization of such technologies would mean that in all of the other embodiments disclosed, wherever data or content is “retrieved” or the like, it may also be received in an unsolicited manner which triggers certain events to take place. By way of a non-limiting example, instead of the Platform Script causing content to be retrieved from the content platform, the Platform Script may not execute code related to content retrieval and may instead simply wait to receive content from the content platform prior to parsing and interpreting any templates in a web page.

In another embodiment, the Platform Script may be realized as multiple components cooperatively operating between the browser 315, web server 330 and content platform 340. By way of a non-limiting example, the Platform Script may continue to provide the browser 315 with communicative abilities to the web server 330 which may execute a separate script, application or software to communicate with the content platform 340 to retrieve content to return to the client device 310. In another non-limiting example, the content platform 340 may execute a script, application or software that interprets the templates and may provide the resultant output, placement data, and/or instructions related to functionality and/or communicative mechanisms to be injected into a page to the client device 310 for utilization by the Platform Script executed by the web browser 315.

In another embodiment, the interpretation of templates may occur through the use of a server-side templating language implementation that occurs on either the web server 330 or the content platform 340 and where the resulting output, placement data, and/or instructions related to functionality and/or communicative mechanisms to be injected into a page is transmitted (whether retrieved or received) to the client device 310 for utilization by the Platform Script executed by the browser 315.

In another embodiment, the interpretation of templates may occur within the content platform where the interpretation of the templates occurs in a client-side context such as by executing the Platform Script of the preferred embodiment on a server in response to a request made from a separate device within the content platform and collecting the output to be utilized, for example via a proxy server, where the output can then be made available to the Platform Script executing in the web browser 315 of the client device 310. In a certain embodiment, multiple servers may be utilized separately or cooperatively to form a server farm capable of processing many requests for output interpretation or transformation.

In another embodiment, output resulting from the interpretation of templates in a client-side or server-side context within the content platform may be made available for incorporation into a web page of web server 330 via an iFrame or other framing or embedding technologies.

In some embodiments, the web servers 330 or 341 may be virtual machines. In some embodiments, any of the components of the platform 340 or the web server 330 may implemented through cloud computing components or services, some of which may operate independently of one another and communicate with one another across the network 320.

In some embodiments, the web server 330 may be operated by the content platform provider to provide the content creator with the option of hosting pages with the content platform provider.

In some embodiment, one or more web servers 330, additional infrastructure components (e.g., load balancers, cache servers, DNS servers, etc.), database servers, application servers, cloud services and so on, may be operated or utilized separately or cooperatively by the content platform provider to operate a hosting infrastructure capable of supporting many content creators.

In some embodiments, page requests sent to a shared infrastructure incorporating one or more web servers 330, additional infrastructure components (e.g., load balancers, cache servers, DNS servers, etc.), database servers, application servers, cloud services and so on and operated or utilized by the content platform provider, are load balanced across the infrastructure and an embodiment of the Platform Script incorporating a client-side templating language implementation is utilized to provide a hosted solution. In other embodiments, disclosed techniques not requiring a Platform Script may be utilized to provide a hosted solution.

In some embodiments, the architecture of the content platform and/or provided hosting services may incorporate the use of “microservices” and/or containerization technologies which may result in requests and responses (or even a single request or response consisting of multiple parts) executing in a distributed manner across one or more servers.

In some embodiments, an incorporated hosting solution may be operated by a third party who is neither the content creator nor the platform provider.

In some embodiments, the content platform and/or hosting infrastructure may be provided by the content platform provider via cloud services which do not require the content platform provider to operate servers. In some embodiments, the platform script may operate entirely on the client side, such that no server-side script is required.

In an embodiment, the Platform Script may be integrated into a web page operated by a third party for purposes other than hosting web pages or websites. By way of a non-limiting example, the Platform Script may be utilized within a social media site which allows users to customize certain pages.

In some embodiments, based on the parsing results, the necessary web data, or content, is retrieved from the platform. For example, parsing the following lines of code (from a template) may require web data, or content, (e.g., images or text) related to all products in the respective category:
{{product.Name}}
{{product.images[0].getImage( )}}

In some embodiments, the templates are transformed into HTML markup, JavaScript, CSS and other markup or code using the retrieved content and then the templates embedded in the web page are replaced with the HTML markup, JavaScript, CSS and other markup or code to render the complete web page. In certain embodiments, a syntax check is performed by the CR script to verify that a template has been used in a safe location within the web page.

In certain embodiments, the CR script supports data scoping. That is, the data model provided to the interpreter will need to be scoped on certain pages within a site. For instance, if a user (e.g., a customer) browses to a specific category or specific product, the browser may be directed to a different web page (a “details” page). According to this embodiment, the CR script recognizes a “details” page and provides an object relevant to the specific product/category. For instance, if the user attempts to observe product #43, the CR script automatically identifies that any reference to the product variable, e.g., {{product.name}}, on that page should automatically resolve to product #43. Detection of referenced objects can be achieved by employing known techniques, such as, but not limited to, URL scanning or query string parameter scanning to locate information pertinent to the data scoping (e.g., looking for a product ID).

Following is a non-limiting example for the operation of the method discussed with reference to FIG. 4. The inclusion of a templating language enables integration of pre-built templates into existing web pages. However, in a typical implementation, the templating language may be used independently of any pre-built templates. The templates may be subsequently edited to allow for further customization.

According to certain configurations, the client device 310, the web server 330, and/or the content platform 340 and/or its servers and/or data warehouses, may include a processing unit coupled to a memory (not shown). The processing unit may comprise or be a component of a processor (not shown) or an array of processors coupled to the memory. The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

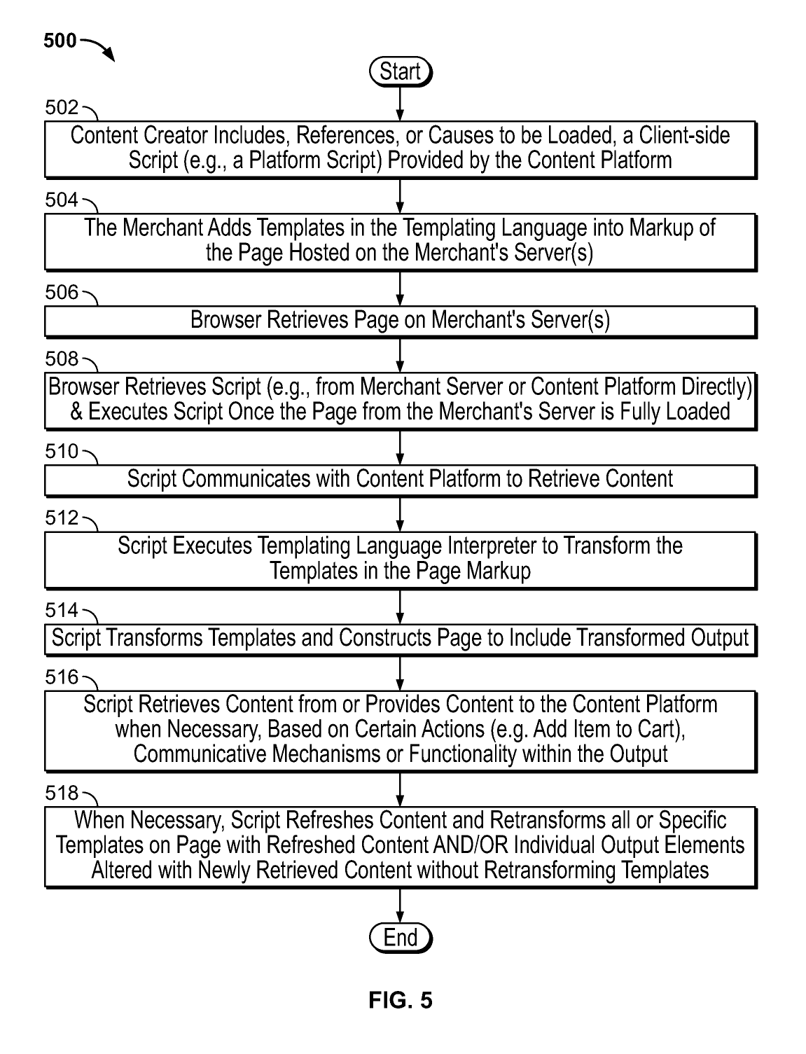

FIG. 5 is a flowchart 500 illustrating an embodiment of the system of the present disclosure wherein the Platform Script is executed on a client device to transform a web page based on communications between the client device and the content platform. In step 502, a content creator, host or merchant can include the Platform Script provided by the content platform. A content platform provider could provide the Platform Script to the merchant or the Platform Script can be provided by a third-party and the content creator can integrate the script, or reference the script, within a web page in an appropriate location (such as the web page markup) so that a browser on a client device can obtain and execute the Platform Script. In step 504, the merchant can add templates in the templating language into a markup of the page hosted on the merchant's server(s). In step 506, the browser can retrieve the webpage on the merchant's server or servers. In step 508, the browser can retrieve the Platform Script from the merchant server and execute the script once the page from the merchant's server is fully loaded. In step 510, the Platform Script can communicate with the content platform to retrieve content. In step 512, the Platform Script can execute a templating language interpreter in order to transform the templates in the page markup. This step may involve providing the retrieved content to the interpreter. In step 514, the Platform Script can transform templates and construct the web page to include the transformed output. The transformed output could include communicative mechanisms, and/or functionality, both of which may be injected into (added to) the web page. In step 516, the Platform Script can retrieve content or provide content to the content platform based on certain actions (e.g., add item to the cart), communicative mechanisms, or functionality within the output. Finally, in step 518, the Platform Script can refresh content and retransform all or specific templates on any page with refreshed content and/or individual output elements altered with newly retrieved content without retransforming the templates. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 500 can occur in a difference sequence and the present disclosure is not limited to the sequence shown and described.

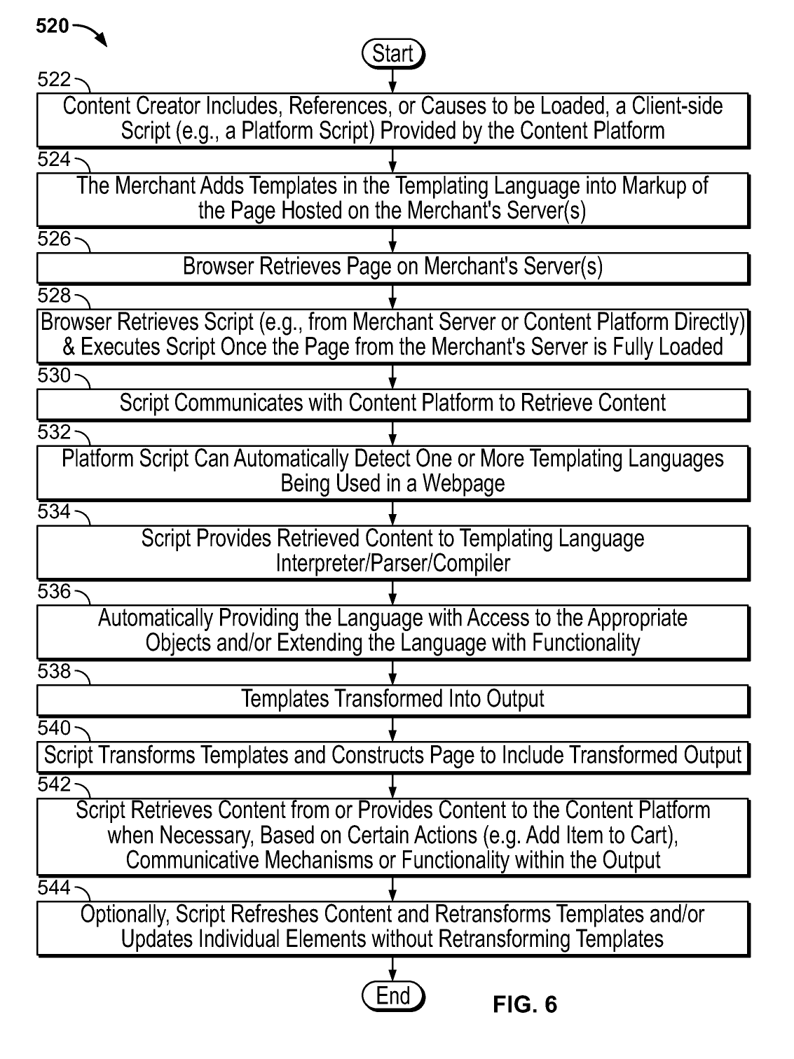

FIG. 6 is a flowchart 520 illustrating another embodiment of the system of the present disclosure wherein the Platform Script transforms a web page by automatically detecting one or more other templating languages utilized within the markup of a web page. In step 522, a content creator, host or merchant can include the Platform Script provided by the content platform. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 524, the merchant can add templates in the templating language into a markup of the page hosted on the merchant's server(s). In step 526, the browser can retrieve the web page on the merchant's server or servers. In step 528, the browser can retrieve the Platform Script from the merchant server and execute the script once the page from the merchant's server is fully loaded. In step 530, the Platform Script can communicate with the content platform to retrieve content. In step 532, the Platform Script can automatically detect one or more templating languages being used in a webpage, for instance by analyzing other script references in the page to ascertain which are languages are being utilized. In step 534, the Platform Script can provide retrieved content to the templating language interpreter, parser, or compiler. In step 536, the system automatically provides the language with access to the appropriate objects and/or extends the language with functionality. For instance, the Platform Script might provide a templating language already in use with access to various objects representing the content obtained from the content platform (e.g., the “store” object), and might attach various methods to certain objects that can then be executed via the templating language that is already in use. Providing additional functionality could be done by extending the language with additional methods such as the create( )method found on some objects. In step 538, the templates are transformed into output. In step 540, the Platform Script can transform templates and construct the web page to include the transformed output. The transformed output could include communicative mechanisms, and/or functionality, both of which may be injected into the webpage. In step 542, the Platform Script can retrieve content or provide content to the content platform based on certain actions (e.g., add item to the cart), communicative mechanisms, or functionality within the output. Finally, in step 544, the Platform Script can refresh content and retransform all or specific templates on any page with refreshed content and/or individual output elements altered with newly retrieved content without retransforming the templates. As with other embodiments, a content platform is made available that can collect, retrieve, and receive data through a management portal but also through automated methods such as API calls (such as shipping quotes through FedEx®), web sockets, or plug-ins. With some templating languages, data refresh may be accomplished by automatic binding, which means no manual transformation of templates is necessary. It should be noted some of the foregoing steps of the flowchart 520 can occur in a difference sequence and the present disclosure is not limited to the sequence shown and described.

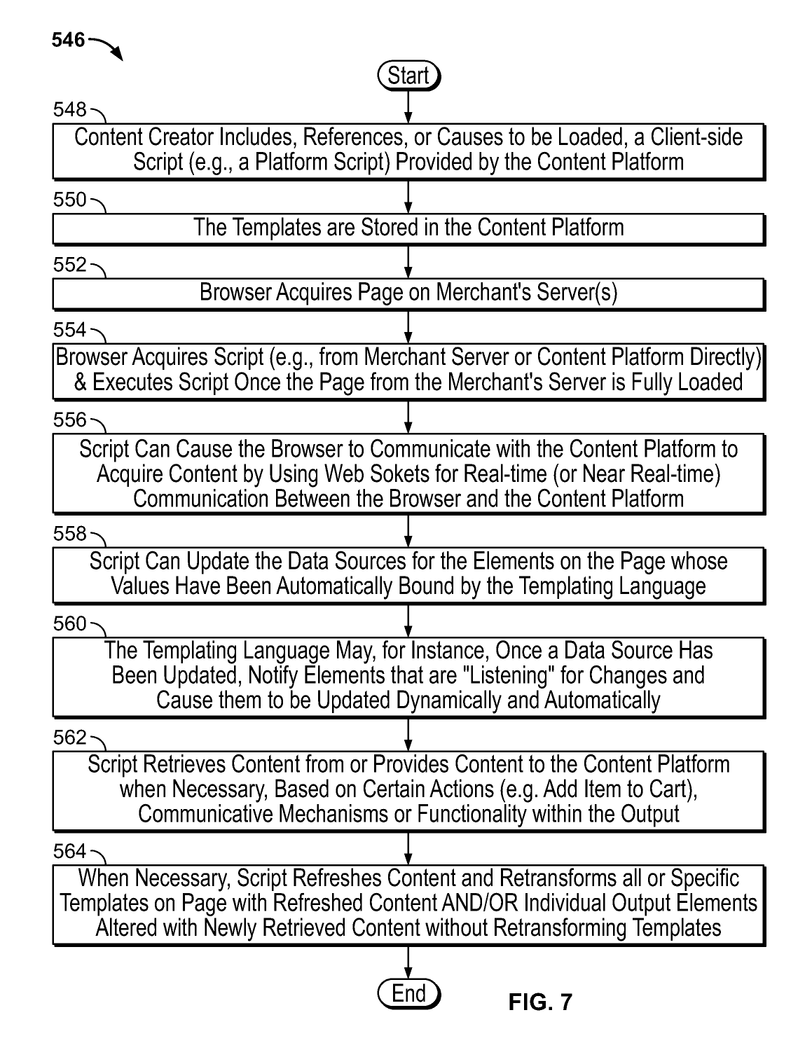

FIG. 7 is a flowchart 546 illustrating another embodiment of the system of the present disclosure wherein the Platform Script transforms a website based on automatic data binding languages and real-time communication with a content platform. In step 548, a content provider, host or merchant can include the Platform Script provided by the content platform. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 550, the templates can be stored in the content platform. In step 552, the browser can acquire the web page on the merchant's server or servers. In step 554, the browser can acquire the Platform Script from the merchant server or from the content platform and execute the script once the page from the merchant's server is fully loaded. In step 556, the Platform Script can cause the browser to communicate with the content platform to acquire content by using web sockets for real-time (or near real-time) communication between the browser and the content platform. In step 558, the Platform Script can update the data sources for the elements on the page whose values have been automatically bound by the templating language. In step 560, the templating language may, for instance, once a data source has been updated, notify elements that are “listening” for changes and cause them to be updated dynamically and automatically. In step 562, the Platform Script can retrieve content or provide content to the content platform based on certain actions (e.g., add item to the cart), communicative mechanisms, or functionality within the output. Finally, in step 564, the Platform Script can refresh content and retransform all or specific templates on any page with refreshed content and/or individual output elements altered with newly retrieved content without retransforming the templates. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 546 can occur in a difference sequence and the present disclosure is not limited to the sequence shown and described.

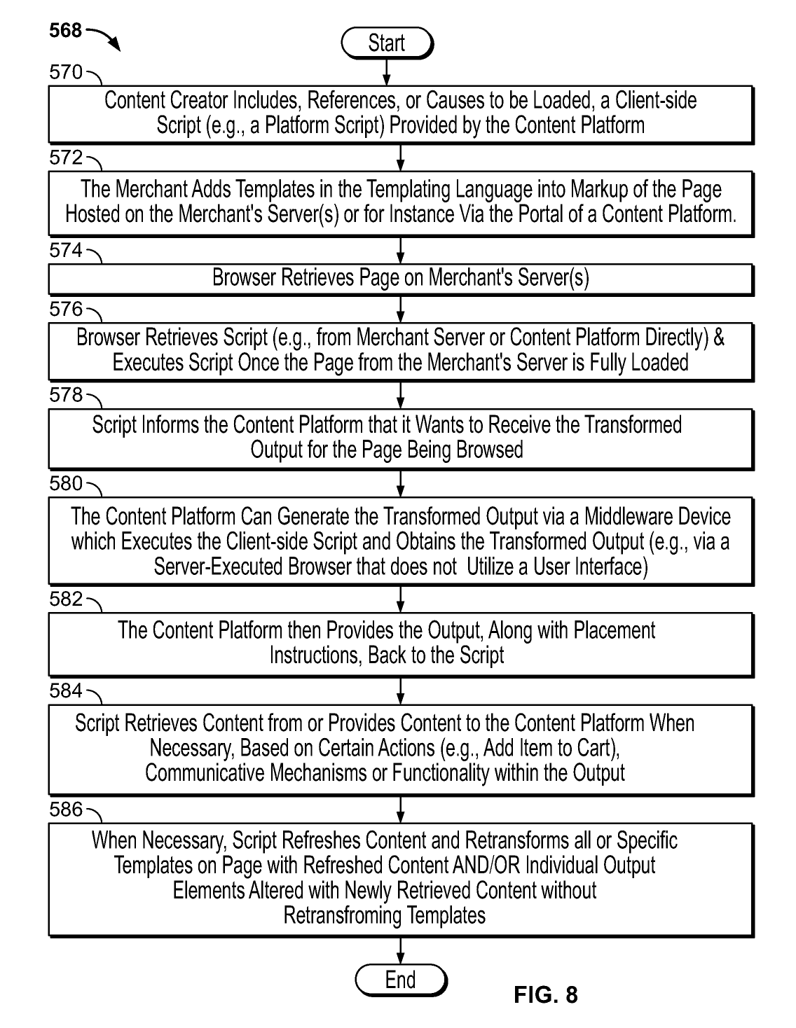

FIG. 8 is a flowchart 568 illustrating another embodiment of the system of the present disclosure wherein a middleware device such as a server is utilized to transform templates prior to the Platform Script obtaining the transformed output and injecting it into a web page. In step 570, a content creator, host or merchant can include the Platform Script provided by the content platform. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 572, the merchant can add templates in the templating language into a markup of the page hosted on the merchant's servers or for instance via the portal of a content platform. In step 574, the browser can retrieve the web page on the merchant's server or servers. In step 576, the browser can retrieve the Platform Script from the merchant server and execute the script once the page from the merchant's server is fully loaded. In step 578, the Platform Script informs the content platform that it wants to receive the transformed output for the page being browsed. In step 580, the content platform can generate the transformed output via a middleware device which executes the client-side script and obtains the transformed output (e.g., via a server-executed browser that does not utilize a user interface). In step 582, the content platform then provides the output, along with placement instructions, back to the Platform Script. The transformed output could include communicative mechanisms, and/or functionality, both of which may be injected into the webpage. In step 584, the Platform Script can retrieve content or provide content to the content platform based on certain actions (e.g., add item to the cart), communicative mechanisms, or functionality within the output. Finally, in step 586, the Platform Script can refresh content and retransform all or specific templates on any page with refreshed content and/or individual output elements altered with newly retrieved content without retransforming the templates. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 568 can occur in a difference sequence and the present disclosure is not limited to the sequence shown and described.

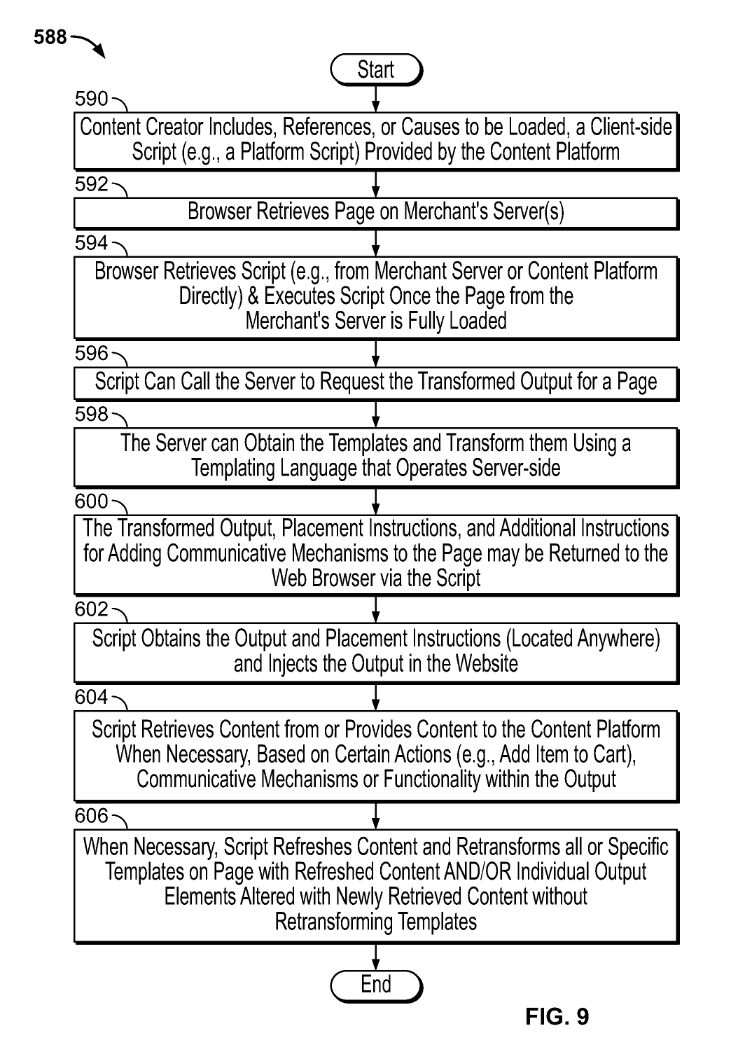

FIG. 9 is a flowchart 588 illustrating another embodiment of the system of the present disclosure wherein processing steps are described for executing parsing and/or interpreting one or more templates or templating language instructions on a server and then incorporating the resulting output into a web page via a platform script. In step 590, a content creator host or merchant can include the Platform Script provided by the content platform. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 592, the browser can retrieve the web page on the merchant's server or servers. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 594, the browser can retrieve the Platform Script from the merchant server or content platform and execute the script once the page from the merchant's server is fully loaded. In step 596, the Platform Script can call the server to request the transformed output for a page. In step 598, the server can obtain the templates and transform them using a templating language that operates server-side. After transformation, in step 600, the transformed output, placement instructions, and additional instructions for adding communicative mechanisms to the page may be returned to the web browser via the Platform Script. In step 602, the Platform Script can obtain the output and placement instructions (which can be located anywhere in the system), and inject the output in the webpage. The transformed output could include communicative mechanisms, and/or functionality, both of which may be injected into the webpage. In step 604, the Platform Script can retrieve content or provide content to the content platform based on certain actions (e.g., add item to the cart), communicative mechanisms, or functionality within the output. Finally, in step 606, the Platform Script can refresh content and retransform all or specific templates on any page with refreshed content and/or individual output elements altered with newly retrieved content without retransforming the templates. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 588 can occur in a difference sequence and the present disclosure is not limited to the sequence shown and described.

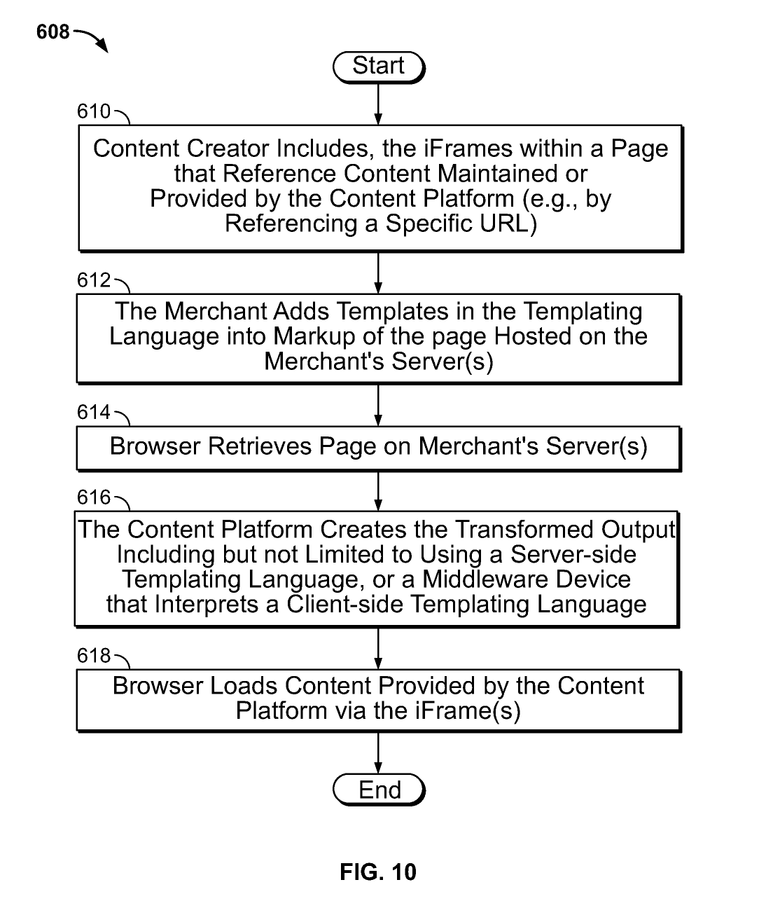

FIG. 10 is a flowchart 608 illustrating another embodiment of the system of the present disclosure wherein iFrames are used to integrate content on a content platform with a website. In step 610, a content creator, host or merchant can include the iFrames within a page that reference content maintained or provided by the content platform (e.g., by referencing a specific URL). In step 612, the merchant can add templates in the templating language into a markup of the page hosted on the merchant's servers, for instance by altering the markup of the page stored in the content platform via a content platform portal, or by specifying templates via the content platform portal that are then stored in a database and indicating where the resulting output should be placed in addition to additional communicative mechanisms to add to the page. In step 614, the browser can retrieve the webpage on the merchant's server or servers. In step 616, the content platform may arrive at the transformed output that it provides to the browser via any of the techniques disclosed, including but not limited to using a server-side templating language, or a middleware device that interprets a client-side templating language. In step 618, the browser loads content provided by the content platform via the iFrame(s). In this particular embodiment, “content” may include a fully transformed page or sections of a page, including further communicative mechanisms. When content within the pages is updated server-side, then the changes will automatically become visible via the web browser. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 608 can occur in a difference sequence and the present disclosure is not limited to the sequence shown and described.

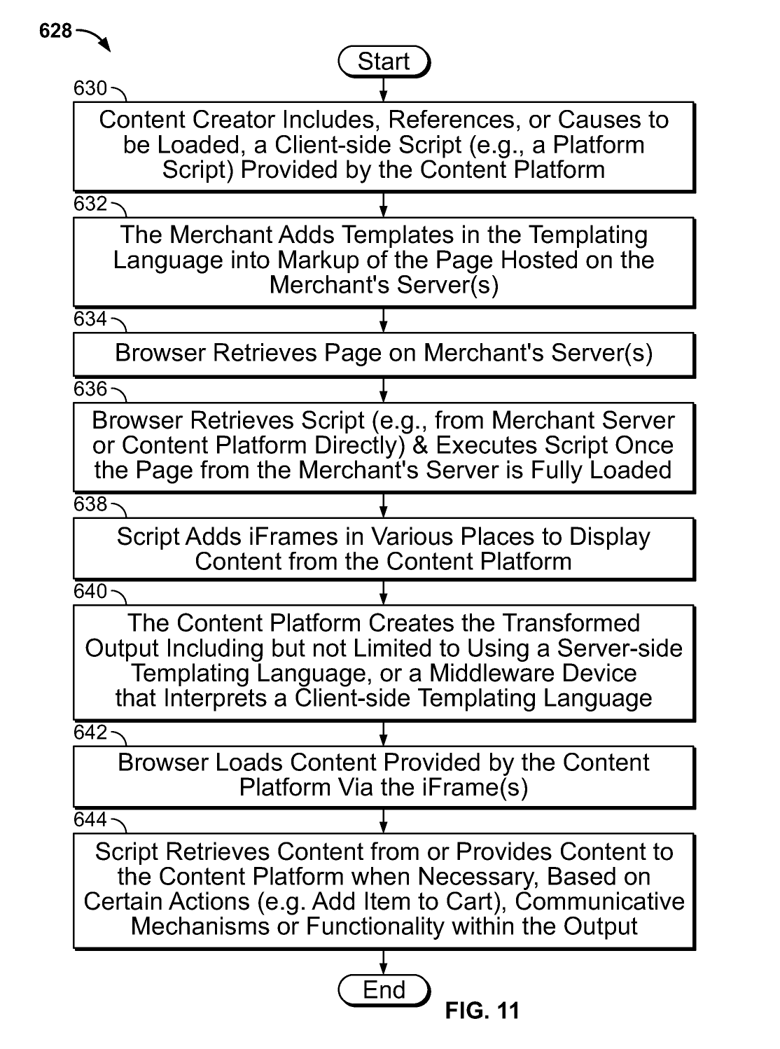

FIG. 11 is a flowchart 628 illustrating another embodiment of the system of the present disclosure wherein iFrames and the Platform Script are used to integrate content on a content platform with a website. In step 630, a host or merchant can include the Platform Script provided by the content platform. A content platform provider could provide the script to the merchant or the script can be provided by a third-party and the content creator can integrate the script, or reference the script, within a web page in an appropriate location (such as the web page markup) so that a browser on a client device can obtain and execute the Platform Script. In step 632, the merchant can add templates in the templating language into a markup of the page hosted on the merchant's servers, for instance by specifying templates in a content platform portal that are stored in a database along with placement instructions that the merchant specifies. In step 634, the browser can retrieve the webpage on the merchant's server or servers. In step 636, the browser can retrieve the Platform Script from the merchant server or content platform and execute the script once the page from the merchant's server is fully loaded. In step 638, the Platform Script can add iFrames in various places of the webpage to display content from the content platform, wherein the placement of the iFrames could either be determined via placement data specified by the merchant (e.g., via a drag and drop operation with a content platform portal that records the location where iFrames are to be placed), via a client-side templating language that indicates where iFrames are to be placed, or via other mechanisms. In step 640, the content platform may arrive at the transformed output that it provides to the browser via any of the techniques disclosed, including but not limited to using a server-side templating language, or a middleware device that interprets a client-side templating language. In step 642, the iFrames, as in FIG. 10, then obtain content from the content platform wherein the content platform is responsible for transforming the output that will be provided via the iFrames. The transformed output could include communicative mechanisms, and/or functionality, both of which may be injected into the webpage. In step 644, the Platform Script can retrieve content or provide content to the content platform based on certain actions (e.g., add item to the cart), communicative mechanisms, or functionality within the output. When content within the pages is updated server-side, then the changes will automatically become visible via the web browser. As with other embodiments, a content platform is made available that can collect, retrieve, and receive data through a management portal but also through automated methods such as API calls (such as shipping quotes through FedEx®), web sockets, or plug-ins. It should be noted some of the foregoing steps of the flowchart 628 can occur in a difference sequence and the present disclosure is not limited to the sequence shown and described.

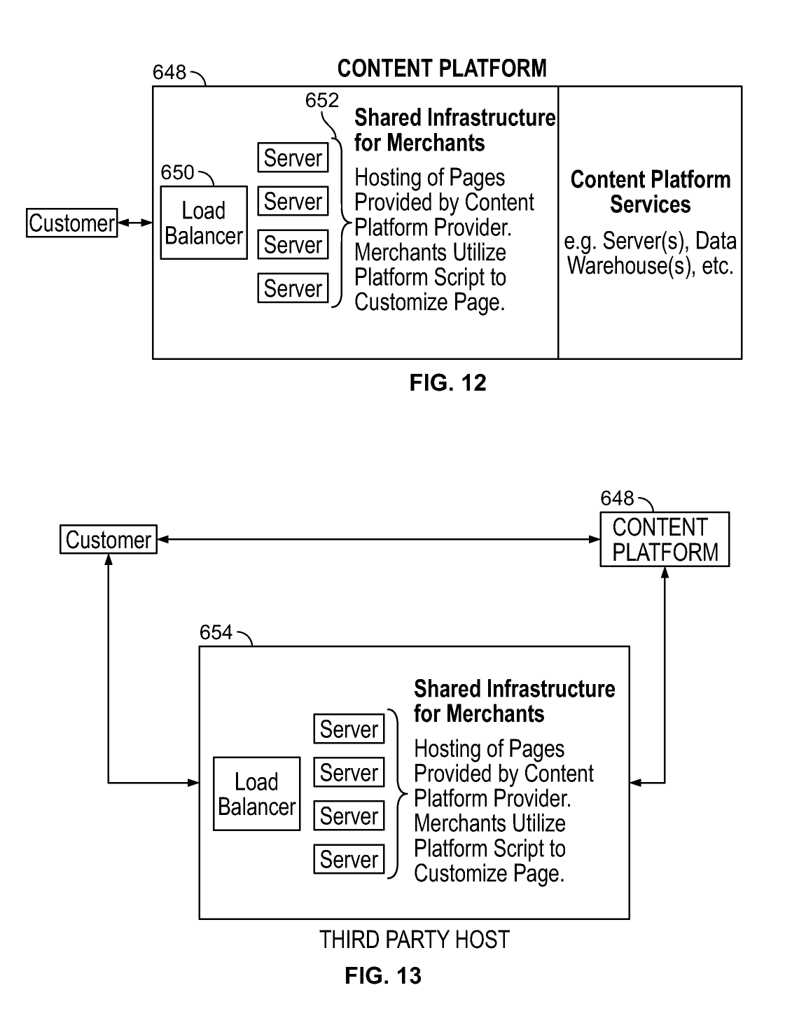

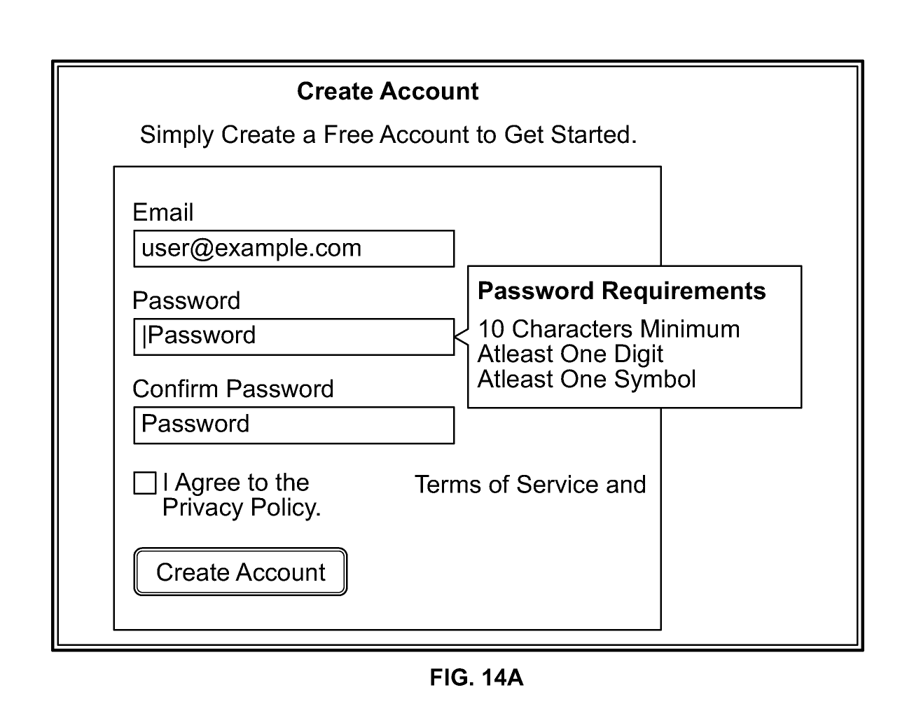

FIGS. 12 and 13 illustrate an implementation of the system of the present disclosure. As shown in FIG. 12, a content platform 648 can include a load balancer 650 for balancing the data load on a plurality of servers 652 for providing a web hosting infrastructure. In this version, the content platform provider may also be the web host provider for the merchant. As shown in FIG. 13, the content platform 648 can be separate from a third party host 654 for hosting the merchant infrastructure. This embodiment can have its own security benefits and scalability benefits.

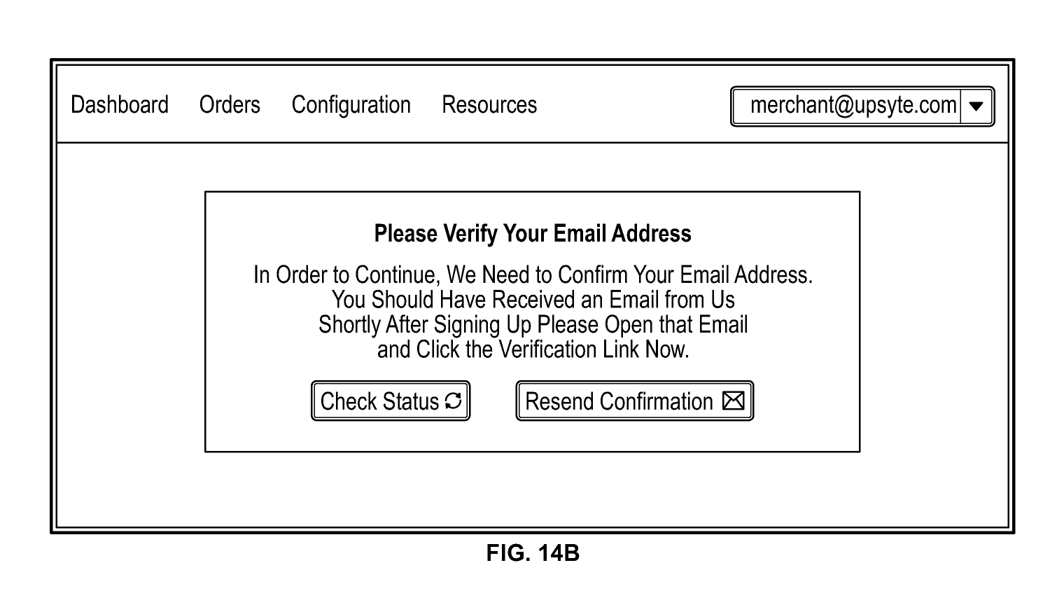

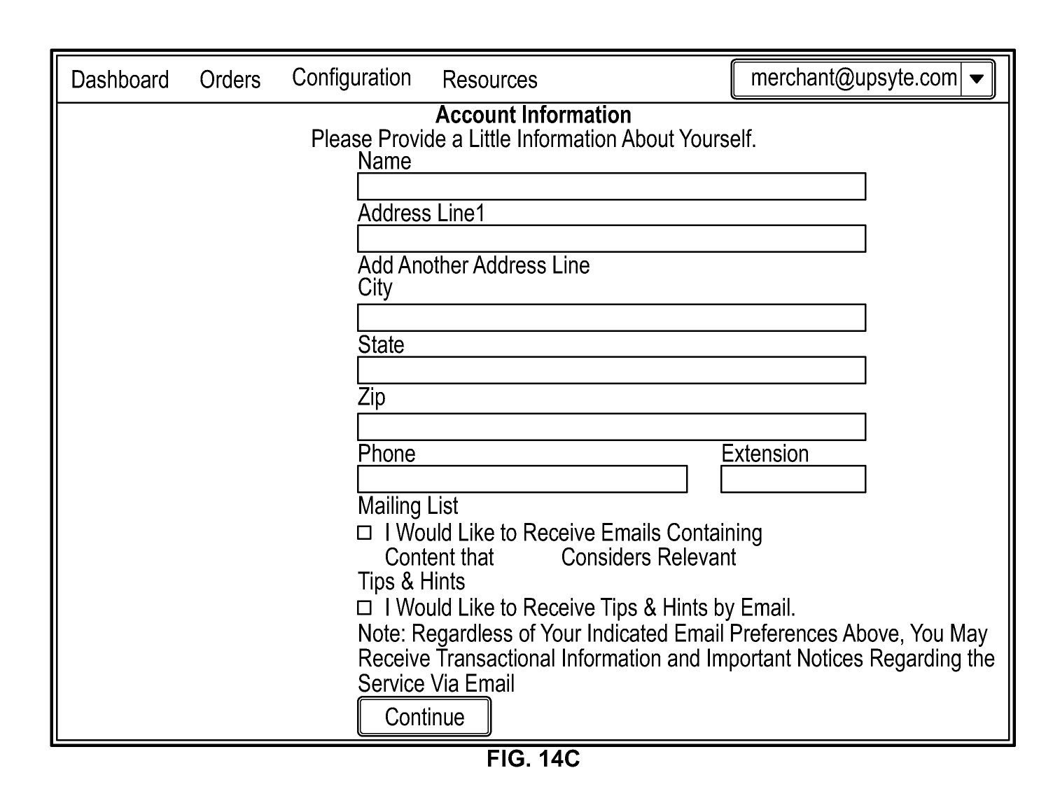

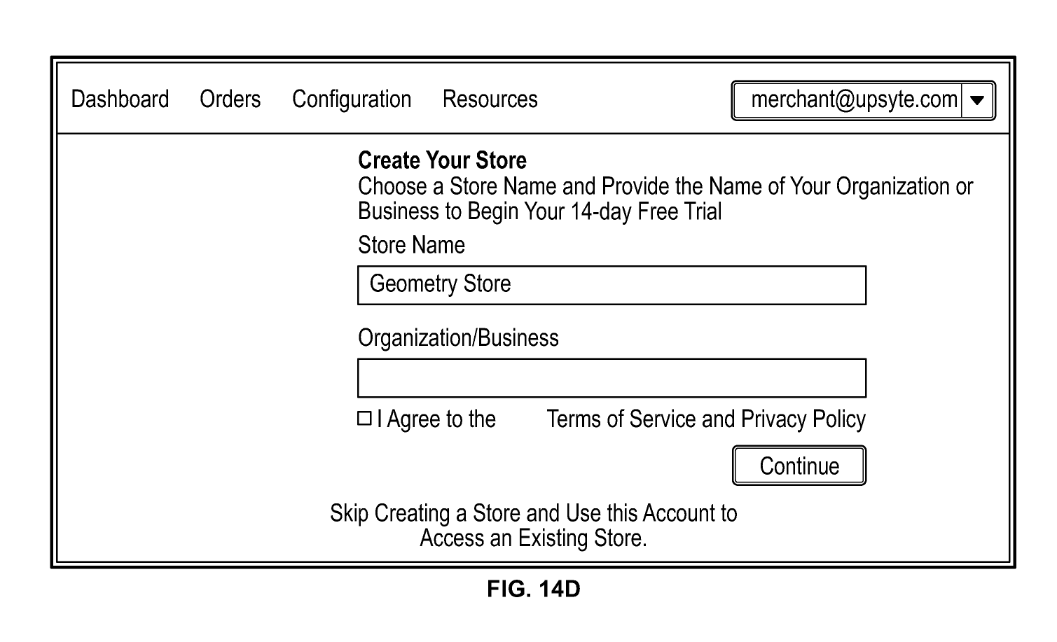

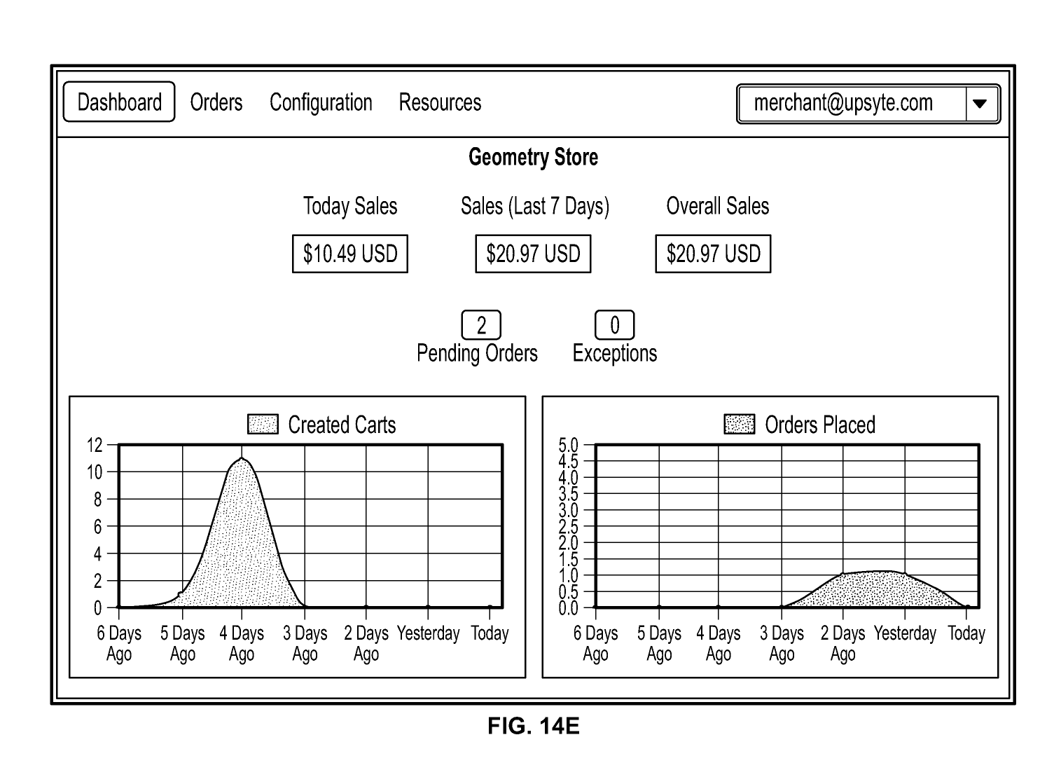

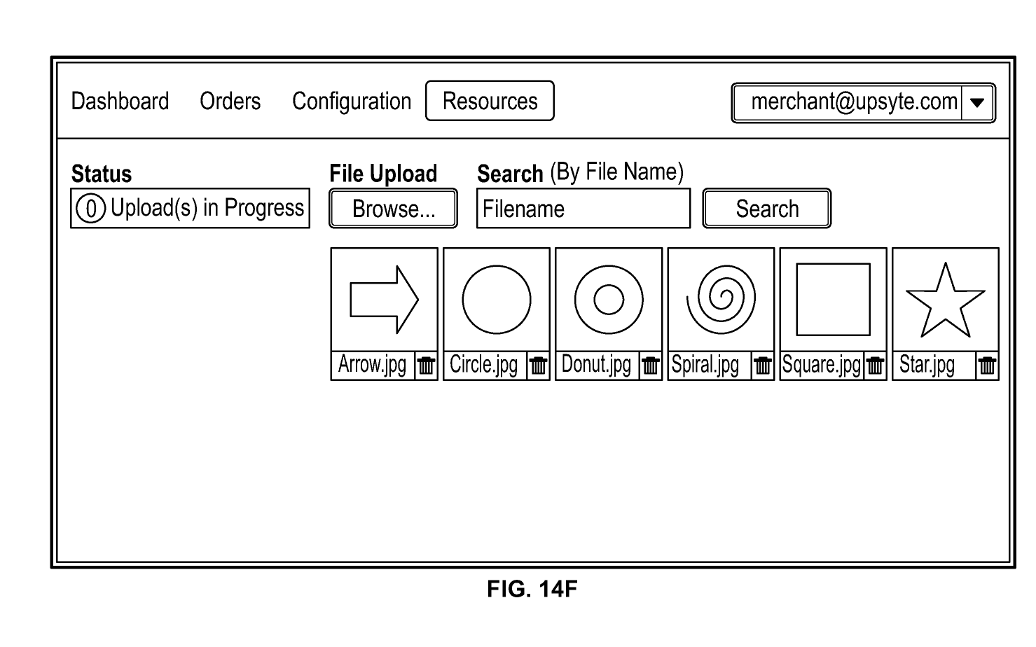

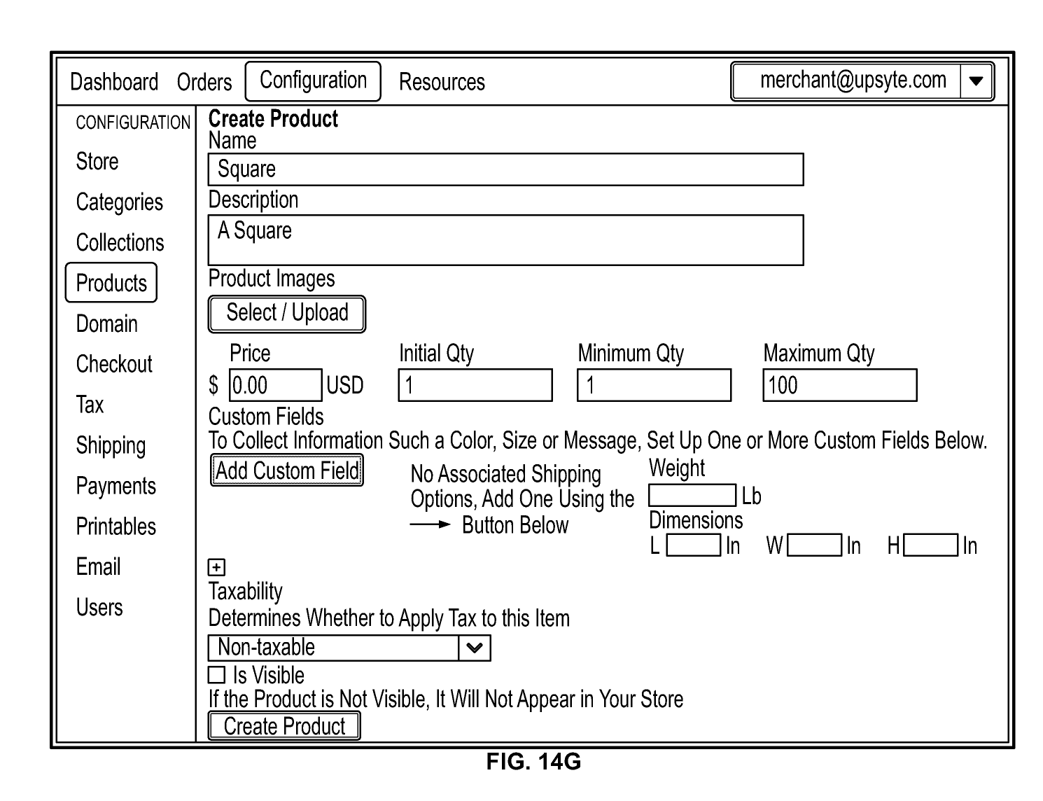

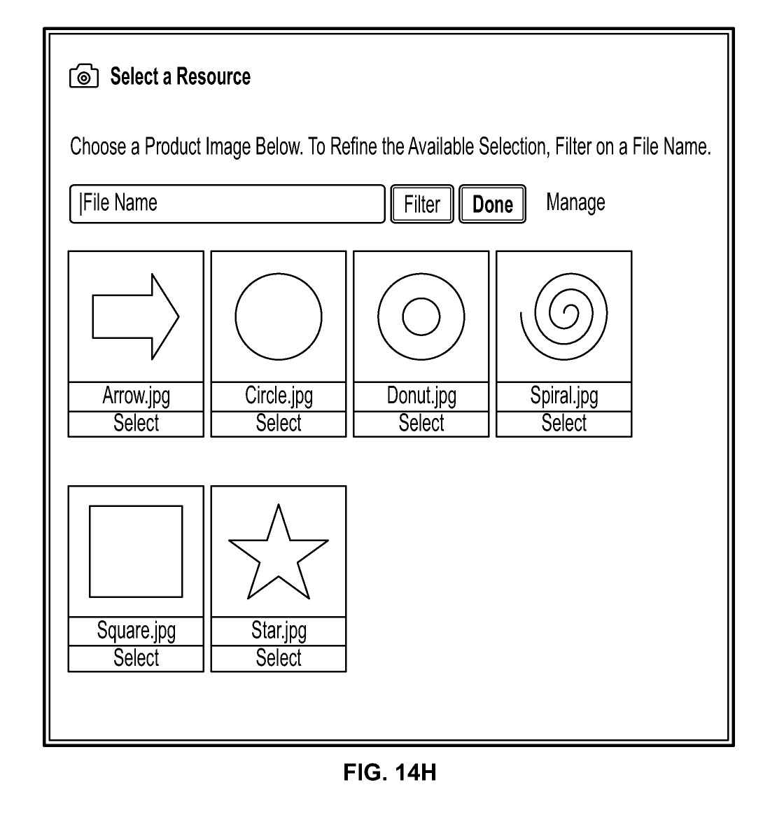

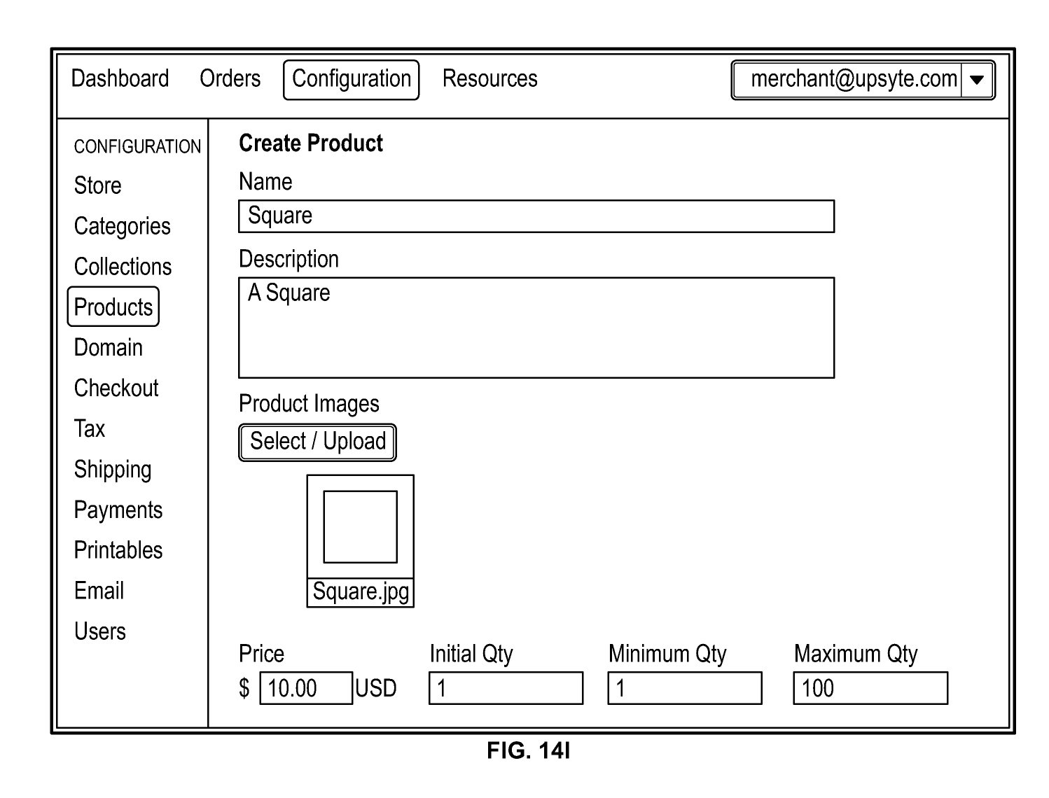

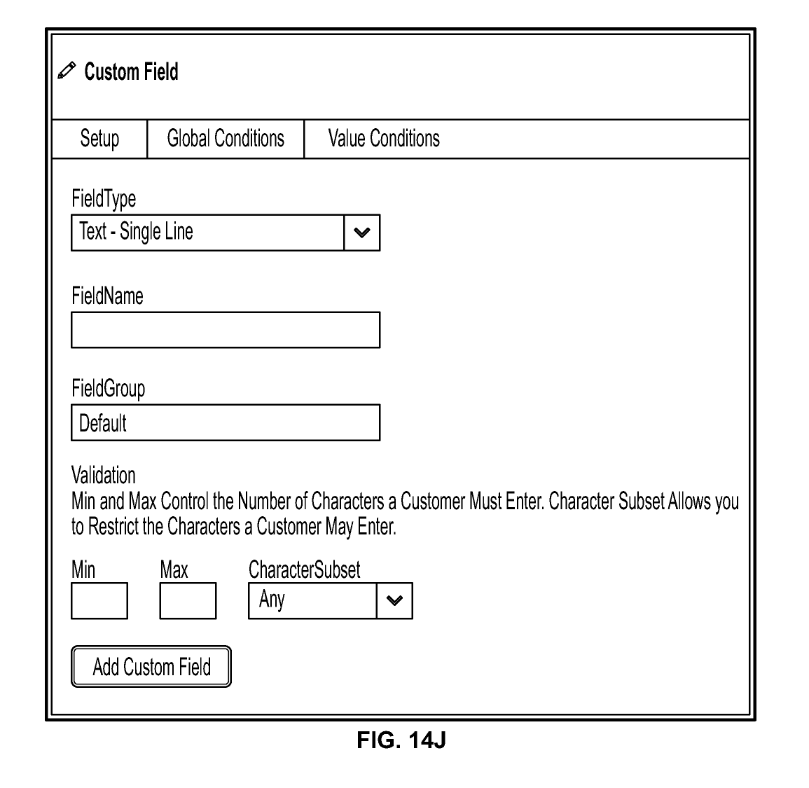

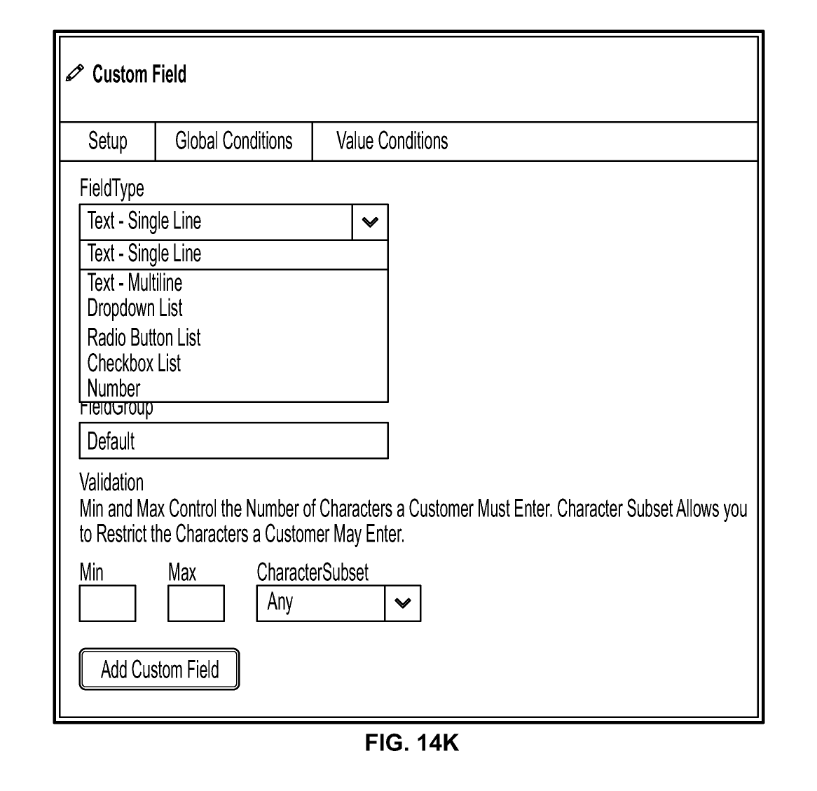

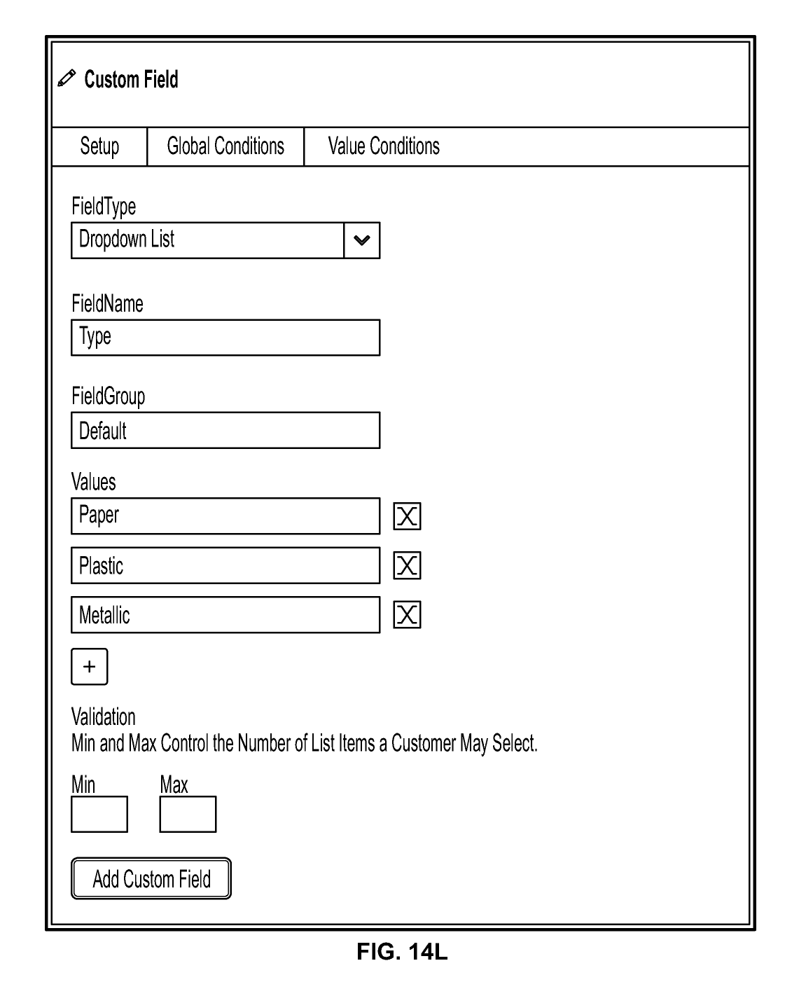

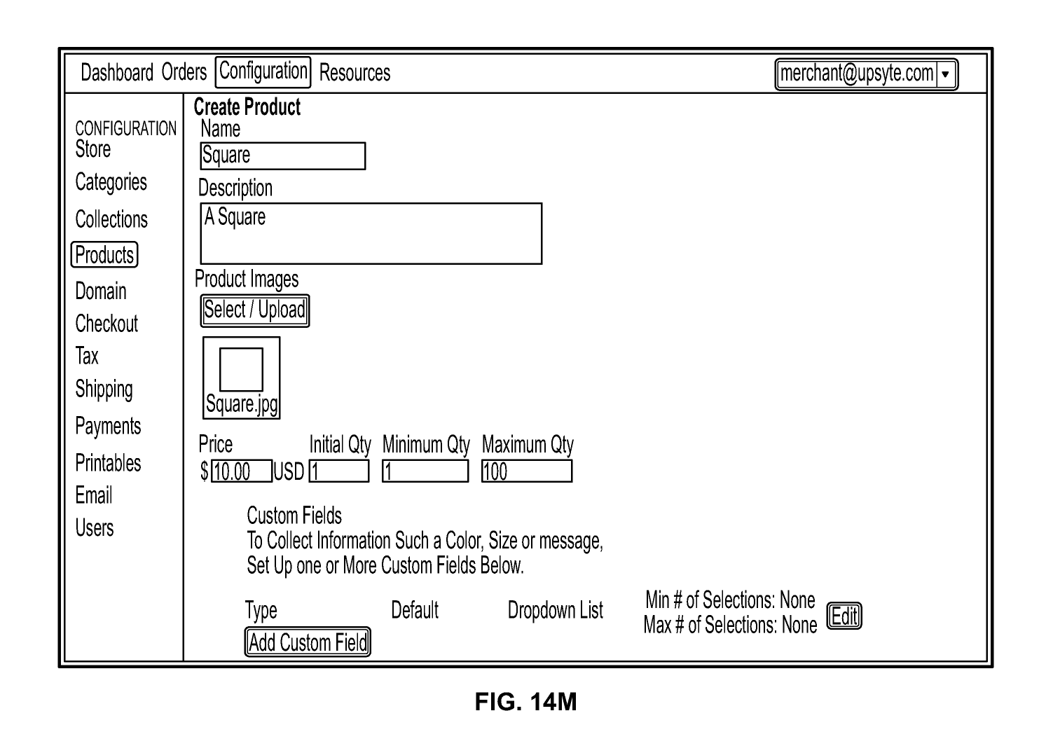

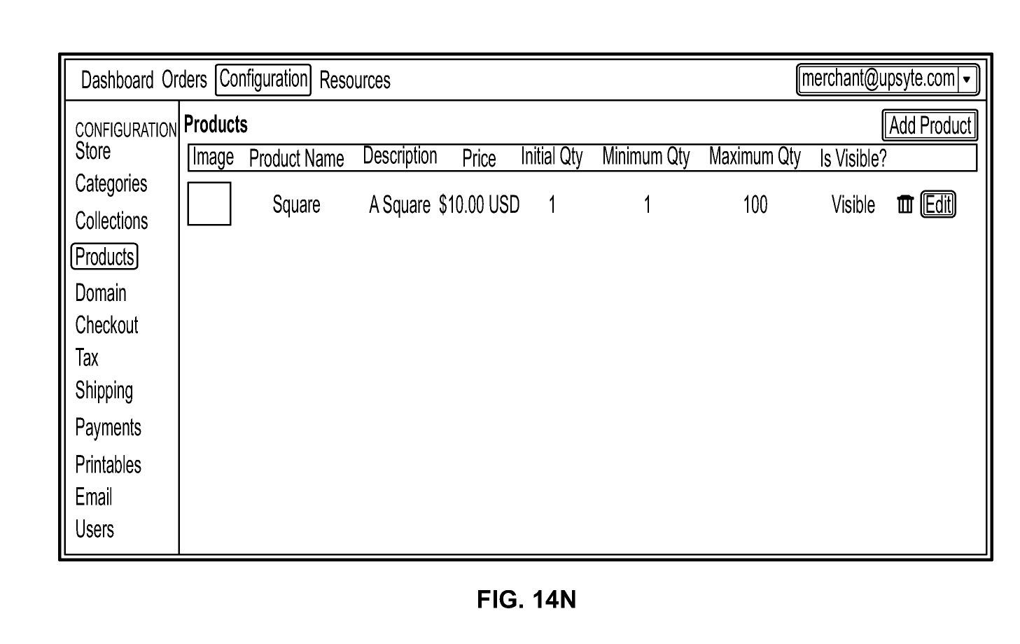

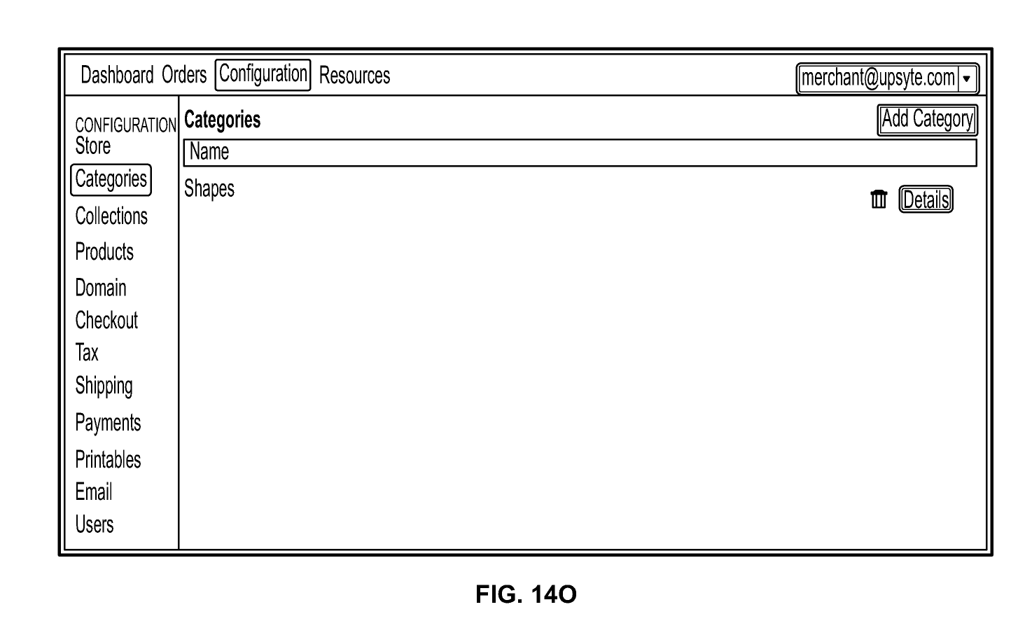

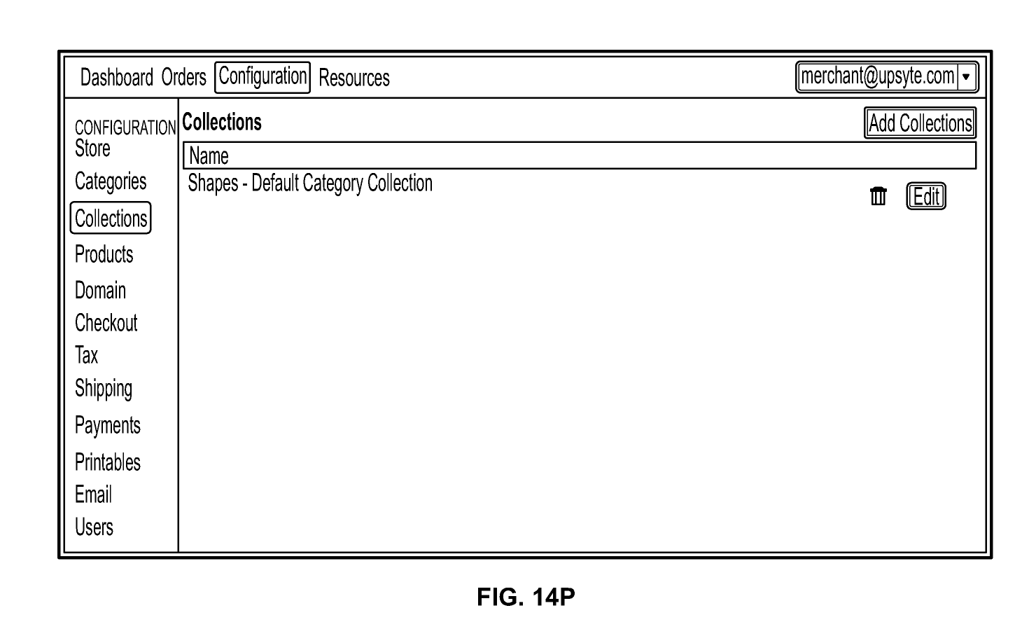

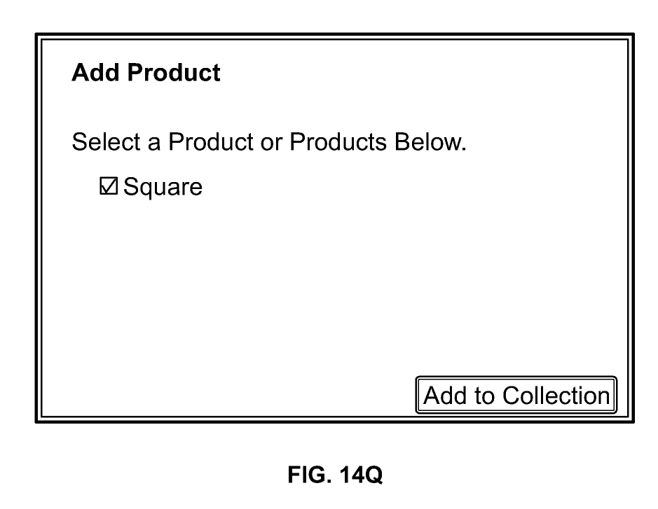

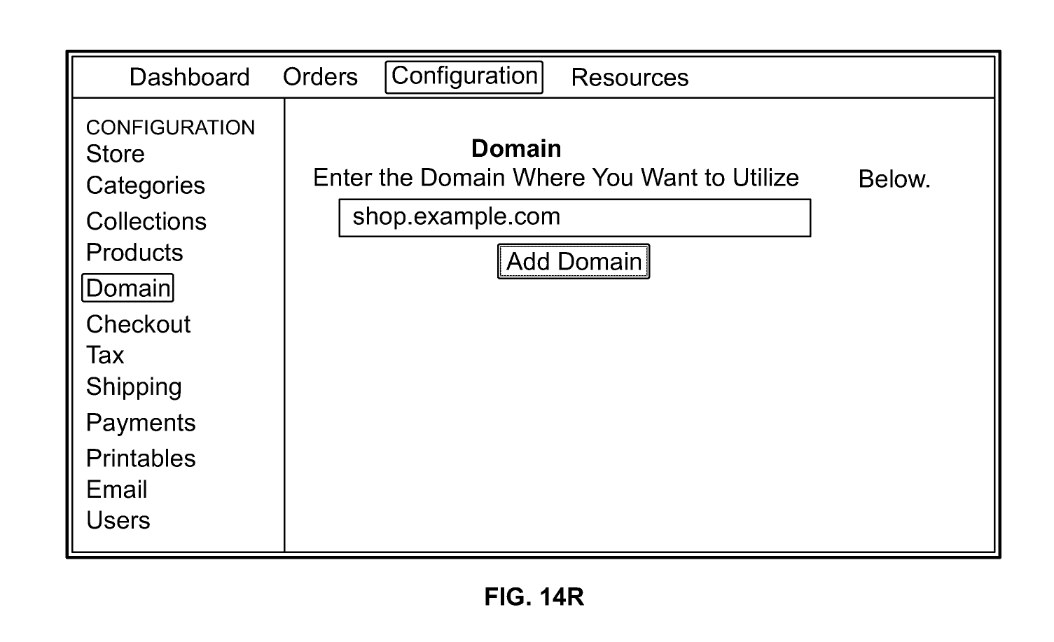

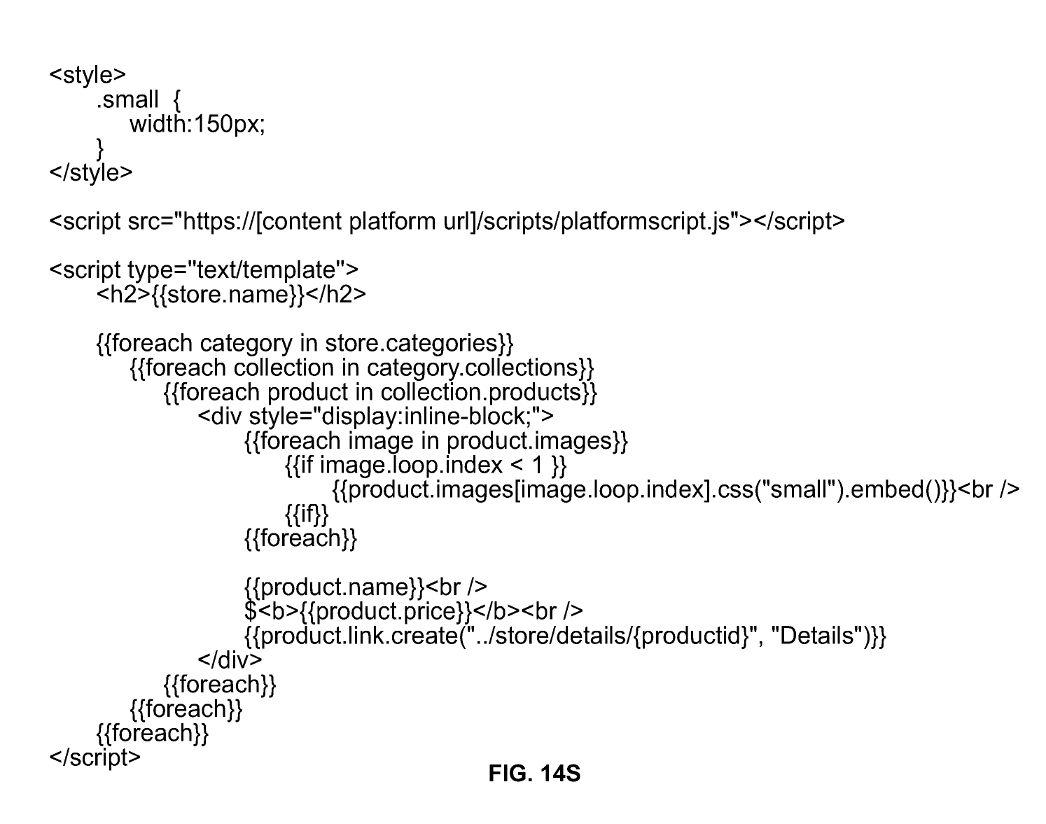

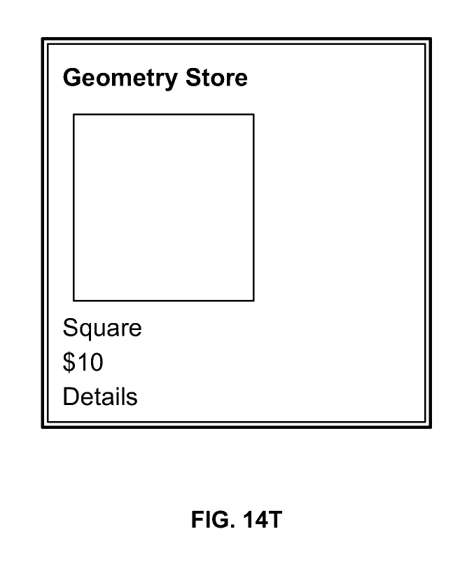

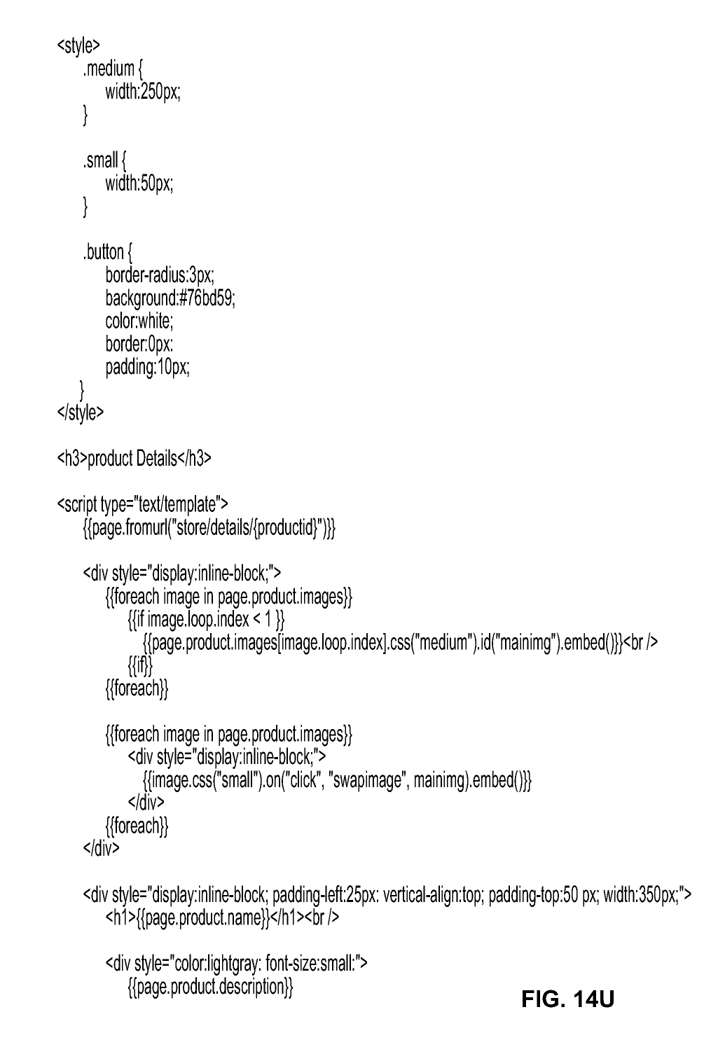

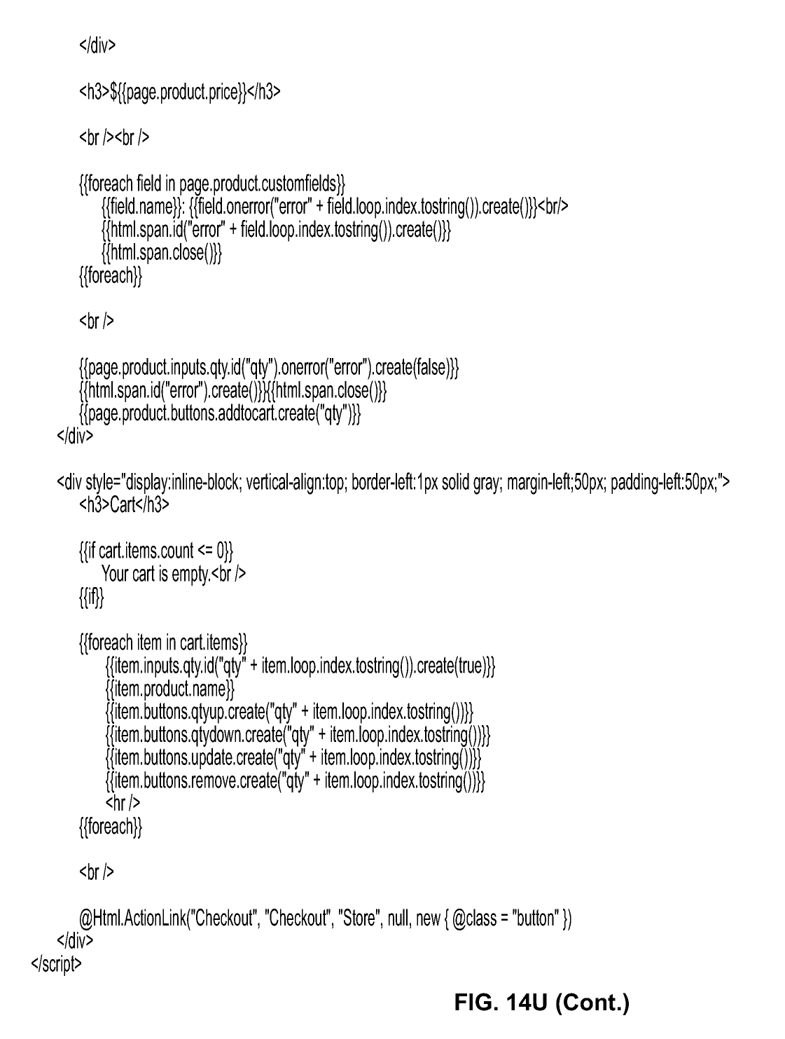

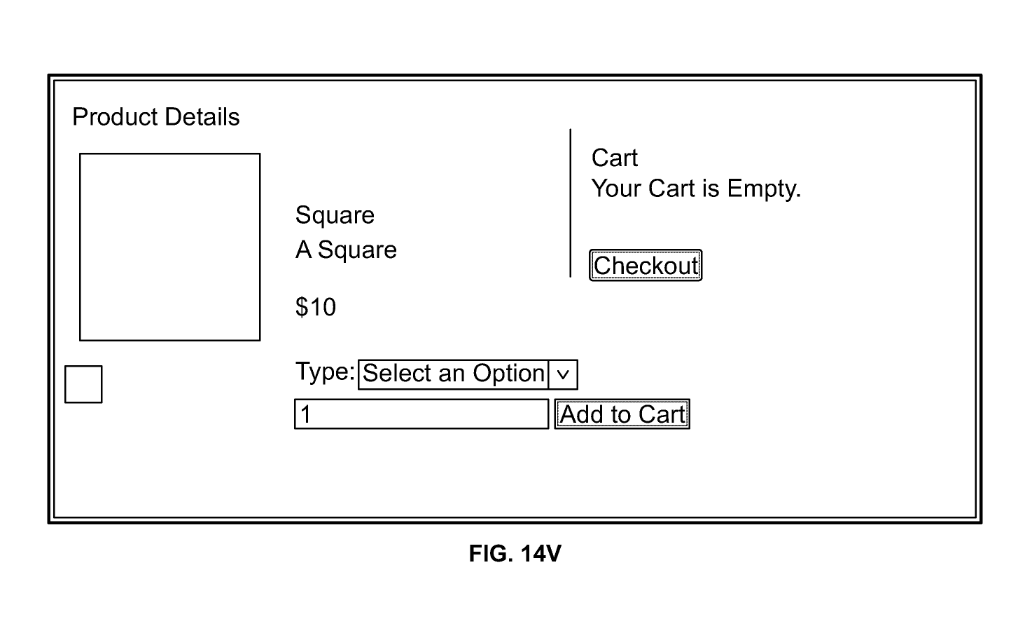

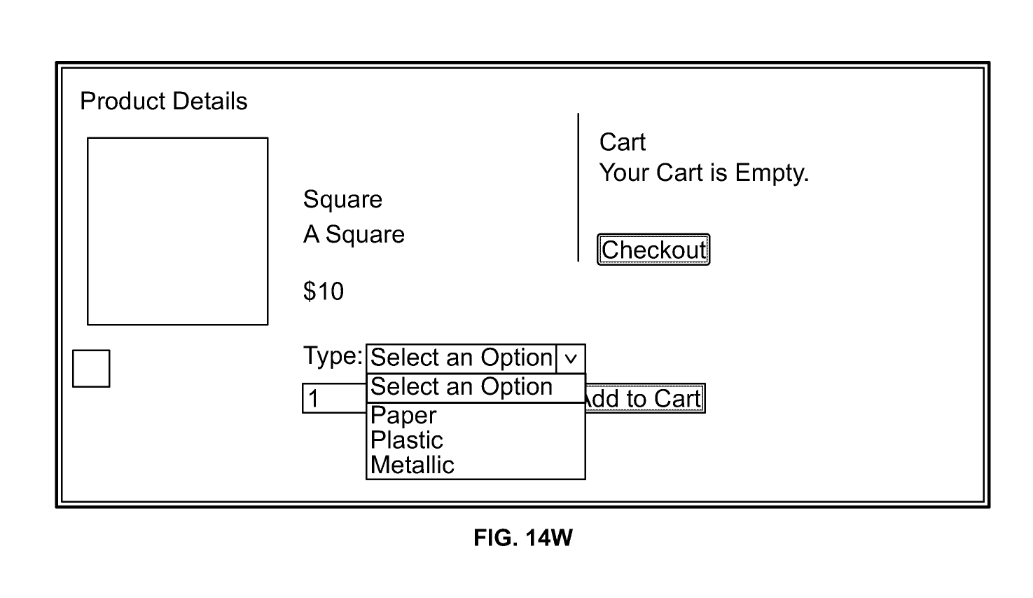

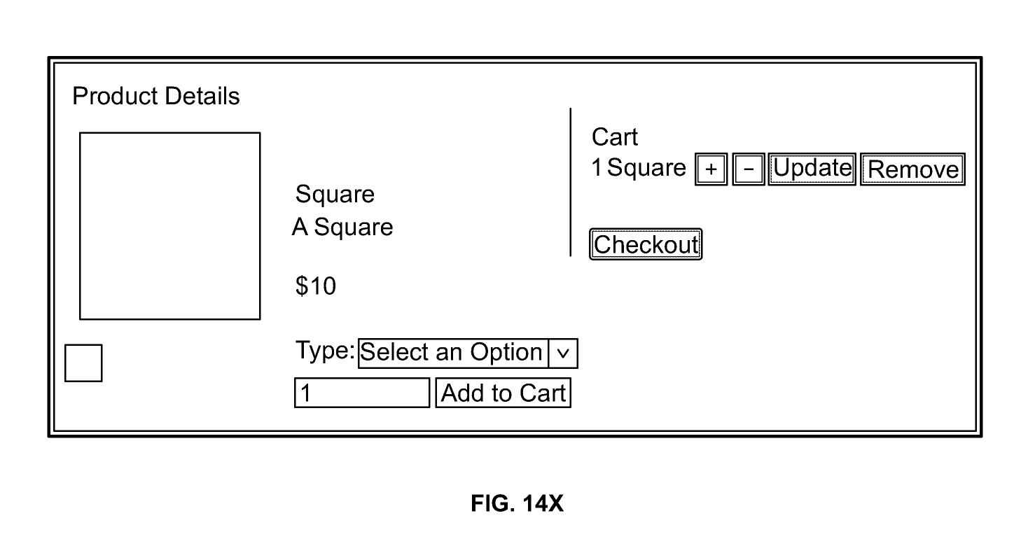

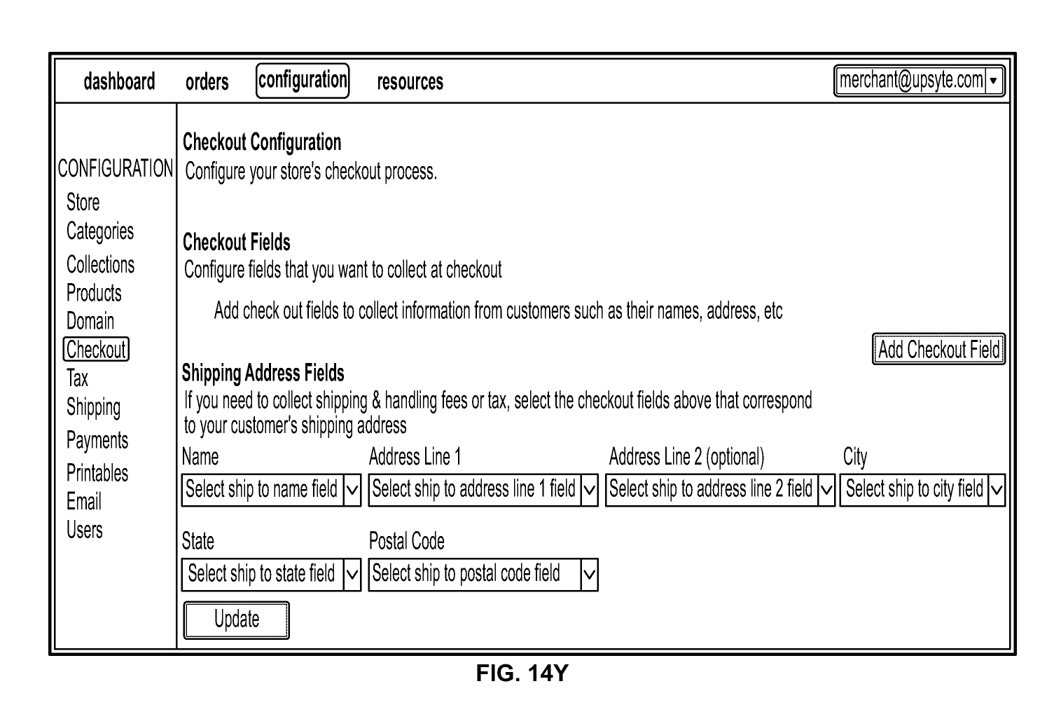

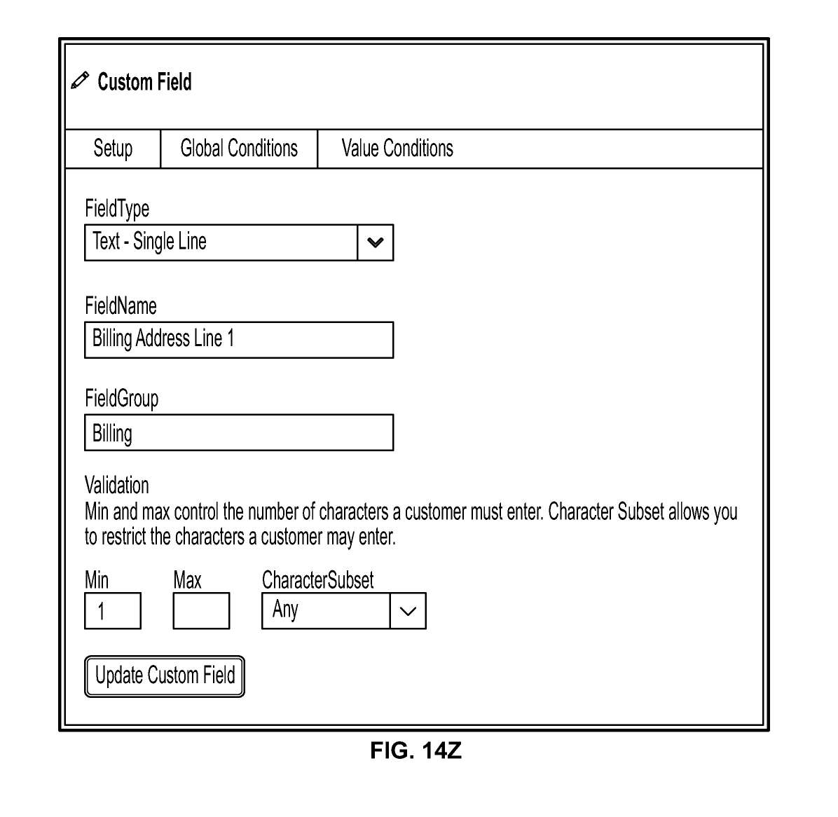

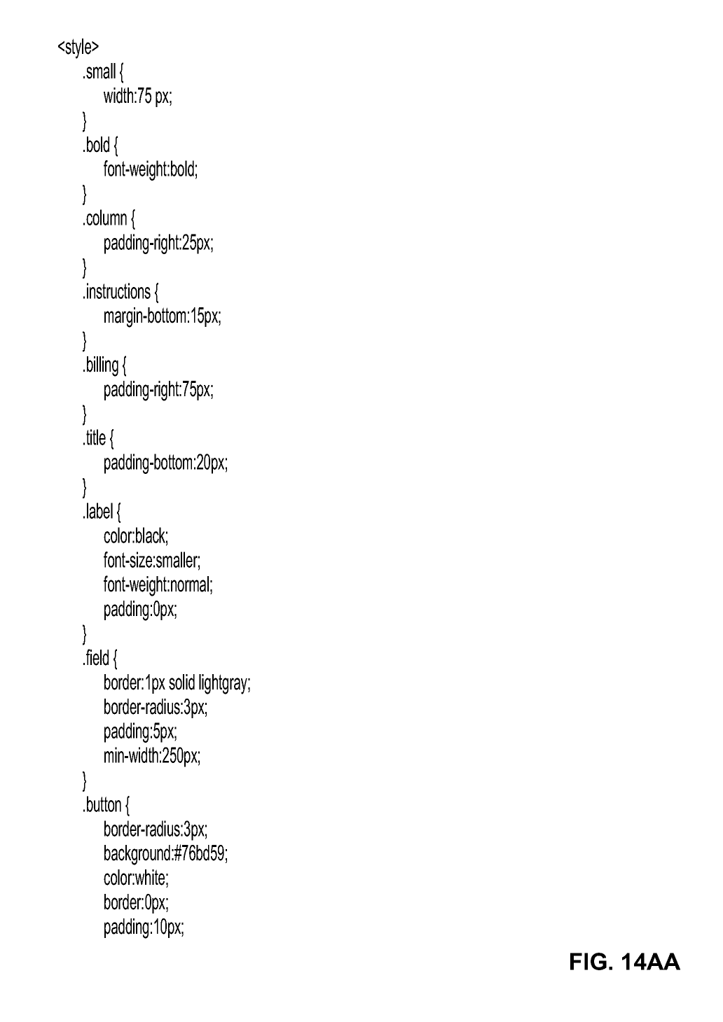

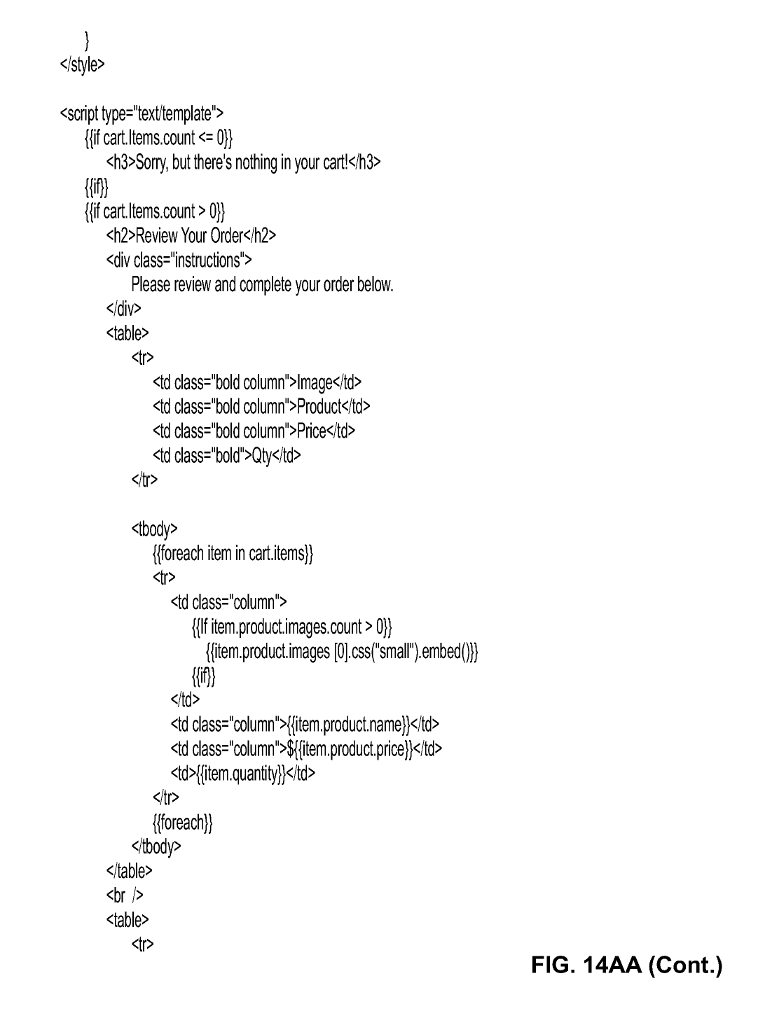

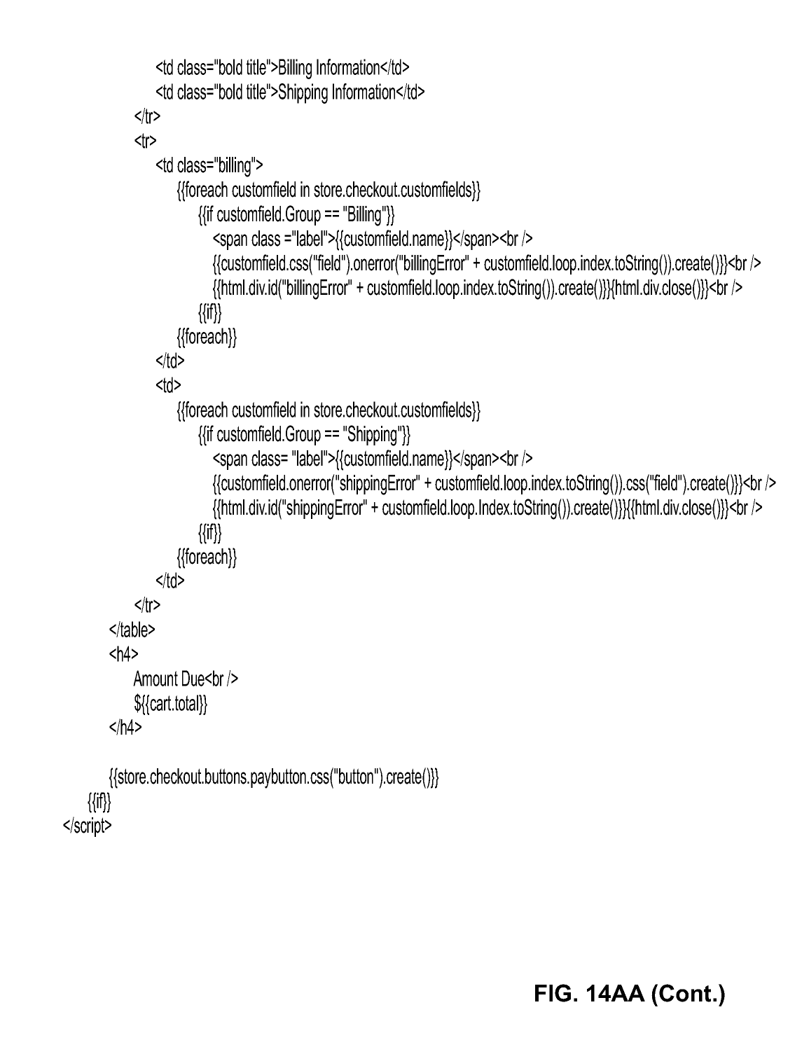

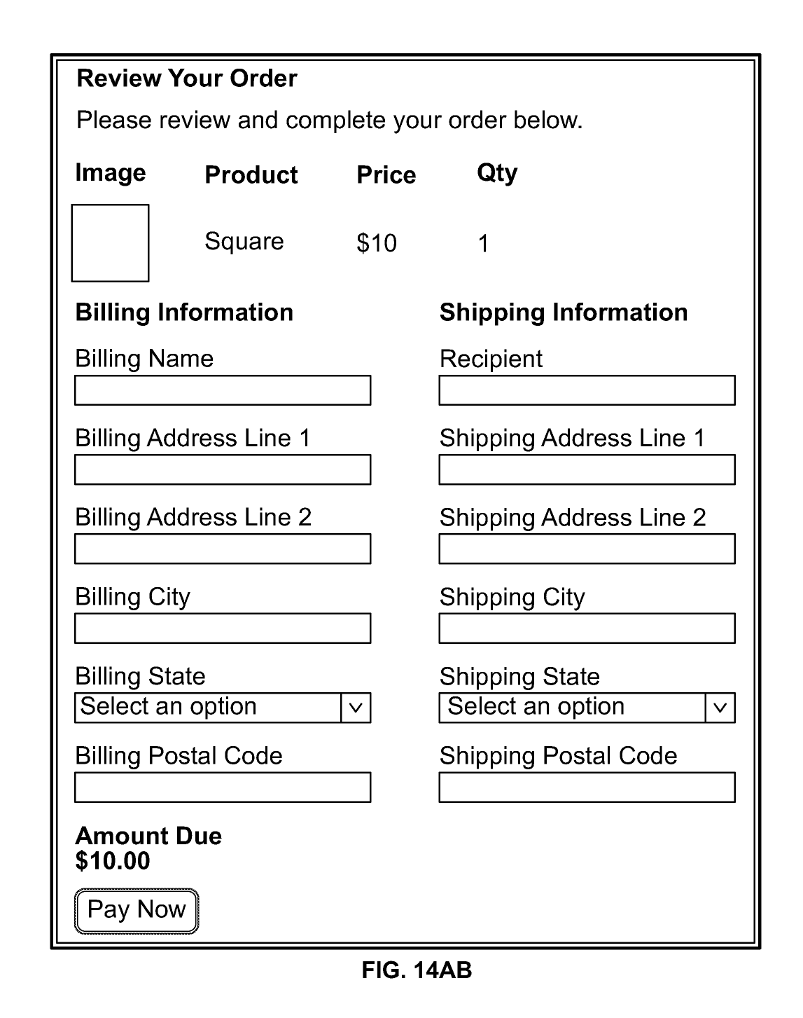

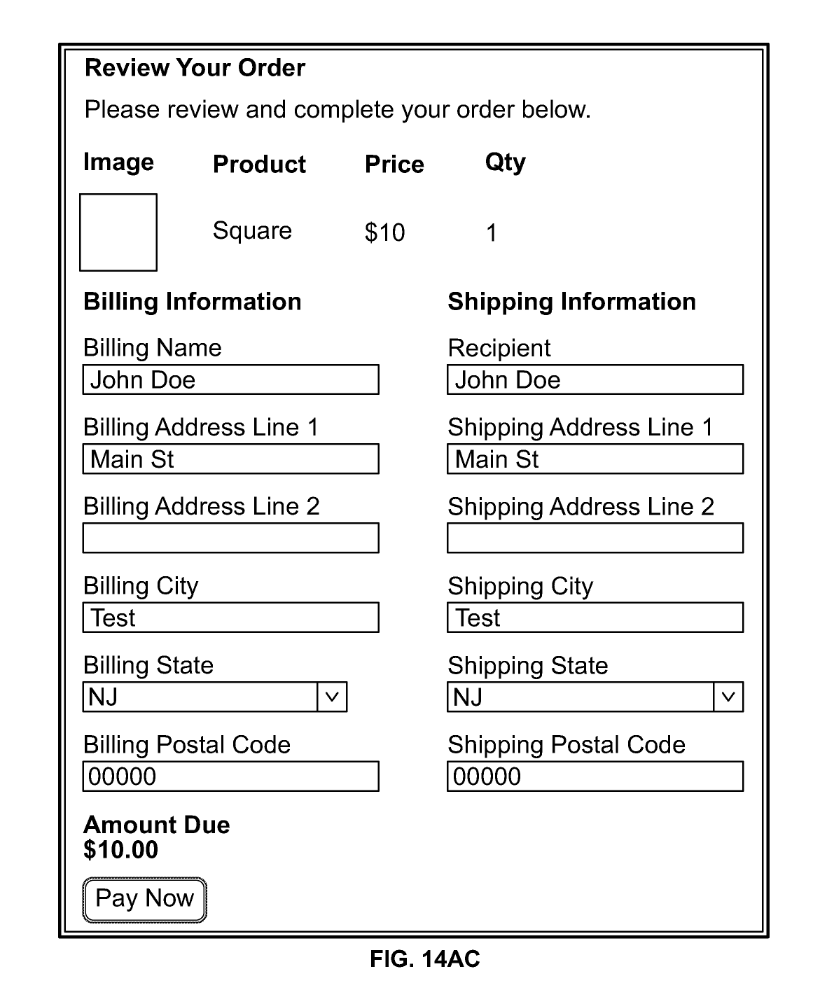

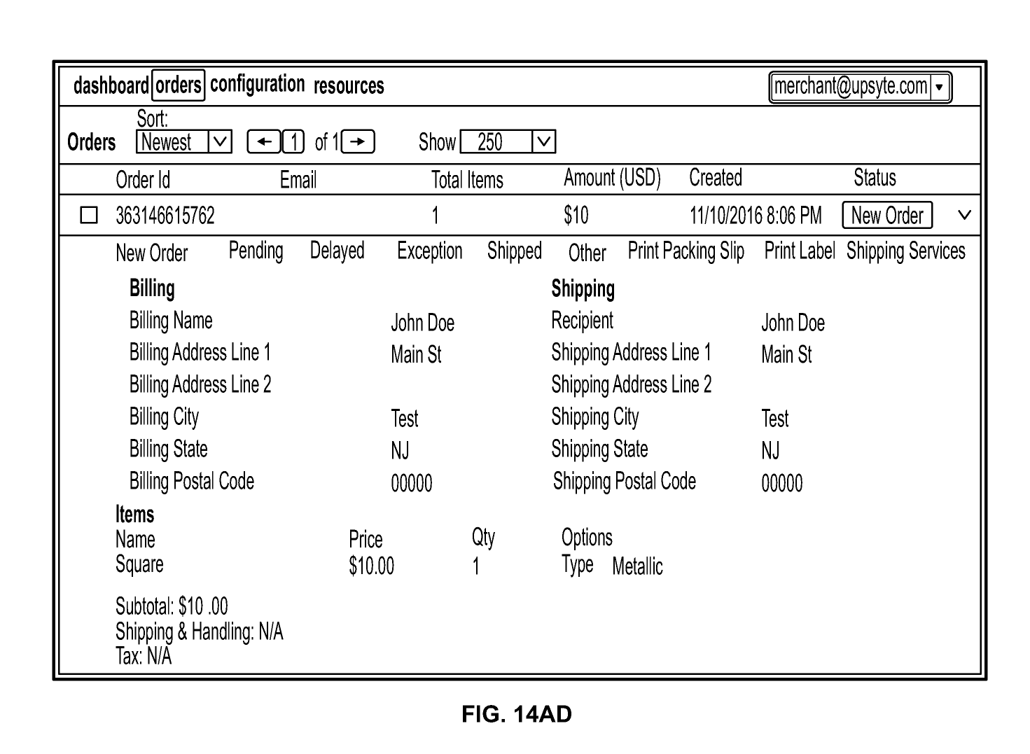

FIGS. 14A-14AD illustrate screenshots of an implementation of the system of the present disclosure. FIG. 14A is a screenshot which illustrates how a user or merchant could register with the content platform, namely, by entering their email address with a password. A create account button can verify the entry of the email and password. FIG. 14B is a screenshot illustrating how a merchant would receive an email link to click on to verify the email addressed entered while creating an account. FIG. 14C is a screenshot which illustrates how a user or merchant provides user identifying information such as a name, address, phone number, etc to create an account. FIG. 14D is a screenshot illustrating how a merchant sets up a trial store by providing a store name and a business name. FIG. 14E is a screenshot illustrating a dashboard of the store showing graphs of carts created and orders places along with the daily sales, sales from the past seven days and overall sales. FIG. 14F is a screenshot illustrating an example of how a user or merchant could upload photos of the products the merchant is trying to sell. For example, a “browse” button can allow a user to navigate to a folder and select from various images in the storage of the user's client device. FIG. 14G is a screenshot illustrating how a merchant could navigate to a screen to enter product information. FIG. 14H is a screenshot illustrating how the merchant can select a resource previously uploaded in FIG. 14F. FIG. 14I is a screenshot illustrating an example of the system after the merchant selects a resource. FIG. 14J is a screenshot illustrating how the merchant can add a custom field to the product. Custom fields enable the free-form collection of information by the platform from within a merchant's website. FIG. 14K is a screenshot showing the merchant a drop down menu for further defining a custom field on the product. For example, there could be a single line text, multiline text, a dropdown list, a radio button list, a checkbox list, and/or a number. FIG. 14L is a screenshot showing a screen when the custom field “type” is set to dropdown list. FIG. 14M is a screenshot showing the create product screen when the custom field has been added. FIG. 14N is a screenshot showing the new product that was created in the system once the “create product” button was clicked. FIG. 14O is a screenshot illustrating how the merchant can add a category to the store. A category is the most basic unit of organization. In an actual store, this might be such as hats, pants, shoes, etc. As an example, here it is shown as a “shapes” category. FIG. 14P is a screenshot illustrating how the merchant can add a collection. A collection allows items within a category to be grouped. FIG. 14Q is a screenshot illustrating how a merchant can edit the collection and link an item to the collection.

FIG. 14R is a screenshot illustrating how the merchant verifies to the system that he or she controls the domain name to be used with the store. The merchant enters the domain to be used with the platform and an email containing a link to click is sent to one of several pre-configured email addresses which only the controller of the domain should have access to such as administrator@example.com. The merchant clicks the link and verifies ownership of the domain. Now that a domain has been associated with the store in question, the system will accept requests from that domain and integration can begin. FIG. 14S is a screenshot of sample web page markup containing templating code for building a catalog view that displays thumbnails of the various products, along with pricing and a link to see more. FIG. 14T is a screenshot of sample output from an example store. It should be noted if additional products were registered as described above, they would show up by executing the template code in FIG. 14S. FIG. 14U is a screenshot of sample web page markup containing templating code for a details page showing the product, price, picture, and other information as could be required by the system. FIG. 14V is a screenshot of the details page output. If there were additional images entered into the system, it would display those images below the main image as shown. Additionally, the additional thumbnail images would be clickable and able to be swapped into the main image position. Also provided is the product name and a selectable option “type” which was previously defined as described above with respect to the product's custom fields. Further this page provides the quantity input, the add to cart button, and the cart display. Additionally, the inputs are validated and the cart automatically functions. FIG. 14W is a screenshot showing the product custom field “type” drop down menu as previously described. FIG. 14X is a screenshot showing a screen when the product has been added to the cart. FIG. 14Y is a screenshot showing a screen to allow the merchant to set up the checkout page. This page allows a merchant to specify what information to collect from a customer at checkout. FIG. 14Z is a screenshot illustrating how a merchant can configure custom fields for the checkout page such as the billing field or shipping field, etc. FIG. 14AA is a screenshot of the web page markup containing templating code for the checkout page. FIG. 14AB is a screenshot of the output of the template code in FIG. 14AA. The code renders the various labels and fields according to those specified in the checkout panel of the portal, validates the input, and causes the captured data to be provided to the portal. There is also a pay button at the bottom of the page. FIG. 14AC is a screenshot of the checkout page filled by a user. FIG. 14AD is a screenshot illustrating the orders page which shows the user or the merchant what orders have been placed, the person who placed the order, the shipping and billing address, the item, the price, the quantity, options, subtotal, etc.

The various embodiments disclosed herein can be implemented as hardware, firmware, software, or any combination thereof. Moreover, the software may be implemented as an application program or tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A system for dynamically integrating web data services and functionality into a web page comprising:
a content platform having content to be integrated into a web page described at least in part by a templating language;
wherein once a user accesses the web page on a device connected to a network, the web page causes a platform script to be executed on the device, the platform script causing the device to parse and interpret the templating language of the web page and to communicate with the content platform to retrieve content and incorporate the content into the web page and to display a transformed output to the user on the device.

2. The system of claim 1, wherein the platform script causes the computer system to communicate in real-time with the content platform for sending and receiving content.

3. The system of claim 1, wherein the platform script causes the computer system to retrieve or provide content from or to the content platform based on at least one of user actions on the website, communicative mechanisms, or functionality within the transformed output.

4. The system of claim 3, wherein the platform script refreshes content by retransforming at least a portion of the webpage with new content from the content platform.

5. The system of claim 3, wherein the platform script refreshes content by altering at least some of the transformed output with new content from the content platform without retransforming templates.

6. The system of claim 1, wherein the platform script can detect the templating language of the web page, automatically extend the functionality of the templating language to add constructs related to the content platform, and automatically provide access to the content of the content platform.

7. The system of claim 1, wherein the templating language comprises at least one type of code or language markup and wherein the templating language can be transformed into output containing one or more types of code or language markup.

8. The system of claim 1, wherein the content platform includes at least one server for distributing content to the computer system.

9. The system of claim 8, wherein the content platform includes a data warehouse for storing the content and the at least one server in communication with the data warehouse for acquiring the content from the data warehouse and distributing the content to the computer system.

10. The system of claim 1, wherein the content platform includes a management portal for customization and performing management tasks.

11. The system of claim 1, wherein the templating language utilizes automatic data binding and wherein once the user accesses the web page on the device, the portions of the web page whose values are automatically bound are updated.

12. A method for dynamically integrating web data services and functionality into a web page comprising the steps of:
providing a content platform having content to be integrated into a web page described at least in part by a templating language;
causing a platform script to be executed on a device once a user accesses the web page on the device;
parsing and interpreting the templating language of the web page once the platform script is executed on the device;
communicating with a content platform to retrieve content and incorporate the content into the web page; and
displaying a transformed output to the user on the device.

13. The method of claim 12, further comprising the step of enabling the computer system through the platform script to have real-time communication with the content platform for sending and receiving content.

14. The method of claim 12, further comprising the step of causing the computer system through the platform script to retrieve or provide content from or to the content platform based on at least one of user actions on the website, communicative mechanisms, or functionality within the transformed output.

15. The method of claim 14, further comprising the step of refreshing content via the platform script by retransforming at least a portion of the webpage with new content from the content platform.

16. The method of claim 14, further comprising the step of refreshing content via the platform script by altering at least some of the transformed output with new content from the content platform without retransforming templates.

17. The method of claim 12, further comprising the step of detecting automatically the templating language of the web page, extending automatically the functionality of the templating language to add constructs related to the content platform, and providing automatically access to the content of the content platform.

18. The method of claim 12, wherein the templating language comprises at least one type of code or language markup and wherein the templating language can be transformed into output containing one or more types of code or language markup.

19. The method of claim 12, further comprising the step of providing at least one server in the content platform for distributing content to the computer system.

20. The method of claim 19, further comprising the step of providing a data warehouse in the content platform for storing the content and the at least one server in communication with the data warehouse for acquiring the content from the data warehouse and distributing the content to the computer system.

21. The method of claim 12, further comprising the step of providing a management portal in the content platform for customization and performing management tasks.

22. The method of claim 12, further comprising the step of providing automatic data bindings within the templating language and updating the portions of the web page whose values are automatically bound once the user accesses the web page on the device.

23. A system for dynamically integrating web data services and functionality into a website comprising:
a device connected to a network for allowing a user to access a web page described at least in part by a templating language; and
a content platform having content to be integrated into the web page;
wherein once the user accesses the web page on the device, the web page causes a platform script to be executed on the device, the platform script causing a remote server to parse and interpret the templating language of the web page and to communicate with the content platform to retrieve content and to send the content to the computer system for incorporation into the web page and display a transformed output to the user on the device.

24. The system of claim 23, wherein the content platform includes at least one server for distributing content to the computer system.

25. The system of claim 24, wherein the content platform includes a data warehouse for storing the content and the at least one server in communication with the data warehouse for acquiring the content from the data warehouse and distributing the content to the computer system.

26. A system for dynamically integrating web data services and functionality into a website comprising:
a device connected to a network for allowing a user to access a web page having iFrames; and
a content platform having content to be integrated into the web page;
wherein the computer system executes the iFrames once the user accesses the web page, the iFrames integrating content from the content platform.

27. The system of claim 26, wherein the content platform includes at least one server for distributing content to the computer system.

28. The system of claim 27, wherein the content platform includes a data warehouse for storing the content and the at least one server in communication with the data warehouse for acquiring the content from the data warehouse and distributing the content to the computer system.
